(19) United States
(12) Patent Application Publication
(10) Pub. No.: US 2007/0089606 A1
(43) Pub. Date: Apr. 26, 2007

(54) Systems and methods for controlling foaming

(76) Inventors: Robert R. Cullen, Glendora, CA (US); Richard J. Sweeney, Fullerton, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/290,637

(22) Filed: Nov. 30, 2005

Related U.S. Application Data
(60) Provisional application No. 60/729,002, filed on Oct. 20, 2005.

(51) Int. Cl. B01D 19/00; A23N 15/00; C09K 3/00

(52) U.S. Cl. 95/241; 426/237; 516/115

(57) ABSTRACT

A foam controlling system uses electromagnetic energy to cut foam on the surface of a solution or liquid in a processing tank into at least two portions prior to the foam propagating and reaching the perimeter of the tank such that currents within the solution or liquid dissipate at least one of the foam portions. A purging fluid is provided to a laser head unit of the foam controlling system to reduce the dew point therein and thereby reduce or substantially eliminate undesirable condensation that could otherwise cause adverse optics contamination. Advantageously, the versatility and simplicity of the foam controlling system as well as its adaptability to various manufacturing formats makes the system an economical full plant solution.

### CROSS REFERENCE TO RELATED APPLICATION(S)

This application claims the benefit of U.S. Provisional Application Ser. No. 60/729,002, filed Oct. 20, 2005, entitled SYSTEMS AND METHODS FOR CONTROLLING FOAMING, the entirety of which is hereby incorporated by reference herein.

### BACKGROUND OF THE INVENTION

1. Field of the Invention

The invention relates generally to systems and methods of controlling foaming in aqueous and non-aqueous solutions.

2. Description of the Related Art

Foam control or reduction in many aqueous or non-aqueous solution based applications and industrial processes is critical for obtaining optimal performance and high process efficiency. One conventional approach utilizes chemical additives for this purpose which can have several undesirable consequences. For example, in the food processing industry, such chemical additives can contaminate, pollute, taint or even cause some level of toxicity in the food product.

Undesirable foam can lead to inefficient mixing, poor productivity, reduced vessel capacity, and equipment failure in many common industrial processes. Such foams can fool sensor devices that monitor liquid levels in critical processes. Some foams can overwhelm a processing plant, disadvantageously shutting down manufacturing. In wastewater treatment, foams build up and entrap bio-organisms that produce foul odors as well as have the potential to overflow causing undesirable production disruption.

As noted above, one conventional approach to control foam build up is a chemical one. Another conventional approach to the control of foam build up is a sonic technology which disadvantageously has inherent environmental issues where plant personnel are in close proximity to the emitting device. Yet another conventional approach is a mechanical technology which has limited adaptability and versatility, in particular, as a whole plant solution.

### SUMMARY OF THE INVENTION

Some embodiments provide a foam controlling system that uses electromagnetic energy to cut foam on the surface of a solution or liquid in a processing tank into at least two portions prior to the foam propagating and reaching the perimeter of the tank such that currents within the solution or liquid dissipate at least one of the foam portions. Some embodiments provide a purging fluid to a laser head unit of the foam controlling system to reduce the dew point therein and thereby reduce or substantially eliminate undesirable condensation that could otherwise cause adverse optics contamination. Advantageously, the versatility and simplicity of the foam controlling system as well as its adaptability to various manufacturing formats makes the system an economical full plant solution.

One embodiment provides a process for controlling foaming. The process comprises providing a tank containing a liquid which generates foam. The tank has fluid flow dynamics which cause foam generated by the liquid to form a patch of foam which increases in size so as to propagate foam in a layer on the surface of the liquid towards the perimeter of the tank. The foam is cut into at least two portions prior to the propagating layer reaching substantially the entire perimeter of the tank, such that currents within the liquid dissipate at least one of the portions of foam.

Another embodiment provides a method for controlling foaming. The method comprises providing a tank containing a liquid which generates foam. A beam of electromagnetic radiation is directed along a beam path towards the foam through at least a portion of a housing. The dew point is reduced along a portion of the beam path within the housing by directing a flow of purging fluid through at least a portion of the housing and out of an opening in the housing.

Yet another embodiment provides an apparatus for controlling foaming in a tank containing a liquid which generates foam. The apparatus generally comprises a housing, a source of electromagnetic radiation and a source of purging fluid. The source of electromagnetic radiation produces an electromagnetic beam. The beam propagates along a beam path through at least a portion of the housing and towards the foam. The source of purging fluid provides the purging fluid to the housing such that dew point along a portion of the beam path within the housing is reduced.

Embodiments of the invention provide several advantages. The systems and methods of controlling foaming in accordance with certain embodiments of the invention desirably make the use of chemical additives obsolete for controlling foam in many aqueous and non-aqueous applications.

The systems and methods of controlling foaming in accordance with certain embodiments of the invention advantageously provide a non-contact approach and can desirably be easily adapted to various configurations. Disadvantageously, conventional mechanical foam controlling technologies are by contact and cannot be easily tailored to the dynamics of many processing formats.

Advantageously, the systems and methods of controlling foaming in accordance with certain embodiments of the invention can be easily tailored or customized to larger scale formats without environment impact to manufacturing plant personnel. Another advantage is that certain embodiments of the systems and methods of controlling foaming are effective in controlling or reducing foam over large areas.

Some embodiments utilize a carbon dioxide (CO₂) laser as an electromagnetic energy source to cut foam and control it. One advantage that justifies the use of the CO₂ laser is its cost effectiveness in power-per-dollar and reliability. Industrial CO₂ lasers have advantageously been proven in the field to last up to 5 years or more without being recharged, even while running continuously. The CO₂ laser of certain embodiments of the invention is advantageously a readily available laser configured for industrial applications. The CO₂ laser desirably provides an economical solution for a majority of applications.

Certain embodiments of the system for controlling foaming can be readily tailored or customized to two-axis geometrical configurations with simple software modifications. Many different coordinate systems can be programmed into the software, as required or desired. Advantageously, replica units can be used in many manufacturing areas creating a full plant solution with a single system design. This desirably allows common spare parts to be shared throughout a manufacturing plant.

For purposes of summarizing the invention, certain aspects, advantages and novel features of the invention have been described herein above. Of course, it is to be understood that not necessarily all such advantages may be achieved in accordance with any particular embodiment of the invention. Thus, the invention may be embodied or carried out in a manner that achieves or optimizes one advantage or group of advantages as taught or suggested herein without necessarily achieving other advantages as may be taught or suggested herein.

All of these embodiments are intended to be within the scope of the invention herein disclosed. These and other embodiments of the invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and some of its features and advantages, certain preferred embodiments and modifications thereof will become apparent to those skilled in the art from the detailed description herein having reference to the figures that follow, of which:

FIG. 1 is a simplified schematic view of a system for controlling foaming illustrating features and advantages in accordance with one embodiment of the invention.

FIG. 2 is a simplified perspective view of a system for controlling foaming illustrating features and advantages in accordance with one embodiment of the invention.

FIG. 3 is a simplified perspective view of a tank containing an aqueous or non-aqueous solution with a patch of foamed thereon illustrating features and advantages in accordance with one embodiment of the invention.

FIG. 4 is a simplified perspective view of a laser and scanning distribution system illustrating features and advantages in accordance with one embodiment of the invention.

FIG. 5 is a simplified perspective view of a laser and scanning distribution system illustrating features and advantages in accordance with one embodiment of the invention.

FIG. 6 is a simplified perspective view of a laser and scanning distribution system illustrating features and advantages in accordance with one embodiment of the invention.

FIG. 7 is a simplified schematic view of a spiral foam cutting pattern illustrating features and advantages in accordance with one embodiment of the invention.

FIG. 8 is a simplified schematic view of a raster foam cutting pattern illustrating features and advantages in accordance with one embodiment of the invention.

FIG. 9 is a simplified schematic view of a petal foam cutting pattern illustrating features and advantages in accordance with one embodiment of the invention.

FIG. 10 is a simplified schematic view of a rectangular foam cutting pattern illustrating features and advantages in accordance with one embodiment of the invention.

FIG. 11 is a simplified schematic view of a circular foam cutting pattern illustrating features and advantages in accordance with one embodiment of the invention.

FIG. 12 is a simplified schematic view of a toggled foam cutting pattern illustrating features and advantages in accordance with one embodiment of the invention.

FIG. 13 is a simplified schematic view of a control panel of a system for controlling foaming illustrating features and advantages in accordance with one embodiment of the invention.

FIG. 14 is a simplified operational flow chart for controlling a system for controlling foaming illustrating features and advantages in accordance with one embodiment of the invention.

FIG. 15 is a simplified schematic view of the formation and propagation of a patch of foam on a surface of a liquid illustrating features and advantages in accordance with one embodiment of the invention.

FIG. 16 are simplified top and side schematic views of cutting of a patch of foam into a plurality (at least two) portions by a system for controlling foaming and dissipation of at least one of the portions illustrating features and advantages in accordance with one embodiment of the invention.

FIG. 17 are simplified schematic views of a patch of foam forming in a relatively stagnant area on a surface of a solution at or near a corner and/or at one or more sides of a processing tank illustrating features and advantages in accordance with one embodiment of the invention.

FIG. 18 is a simplified schematic view of a source of purging fluid reducing dew point along a portion of a beam path within a housing of a system for controlling foaming illustrating features and advantages in accordance with one embodiment of the invention.

FIG. 19 is a simplified schematic view of a system for controlling foaming illustrating features and advantages in accordance with a modified embodiment of the invention.

FIG. 20 is a simplified perspective view of a system for controlling foaming illustrating features and advantages in accordance with a modified embodiment of the invention.

FIG. 21 is a simplified perspective view of a system for controlling foaming illustrating features and advantages in accordance with a modified embodiment of the invention.

FIG. 22 is a simplified side view of a system for controlling foaming illustrating features and advantages in accordance with a modified embodiment of the invention.

### DETAILED DESCRIPTION OF THE PREFERRED EMBODIMENTS

The preferred embodiments of the invention described herein relate generally to systems and methods of controlling foaming in aqueous and non-aqueous solutions and, in particular, to controlling foaming by a laser and a scanning distributing apparatus which cuts foam into at least two portions so that at least one portion is dissipated and/or collapsed, and reducing dew point along at least a portion of a beam path of the laser to advantageously provide for substantially optimal performance and substantially eliminate optic contamination.

While the description sets forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described herein.

Some embodiments of the system for controlling foaming comprise a laser head and a controls enclosure or cabinet connected by a duct. In one embodiment, the laser head generally comprises an outer housing, a laser, a lens system (collimator), a beam scanner and a shutter system. In one embodiment, the controls enclosure generally comprises a computer, a power supply, electronics and a panel interfaced with the computer. An antenna may provide wireless connection to a PDA or other hand held wireless device, as required or desired. In one embodiment, a source of purging fluid provides conditioned air to the laser head through the duct to reduce and/or control the dew point to substantially eliminate contamination of optics.

Some embodiments of the system for controlling foaming comprise a laser as an electromagnetic energy source. In one embodiment, the laser has an output power of about 100 Watts. In another embodiment, the laser has an output power of about 200 Watts. In modified embodiments, other suitable laser output powers may be efficaciously used, as required or desired.

Advantageously, certain embodiments of the invention control foam without the use of undesirable chemical additives. Another advantage is that the system allows for programmable scan patterns, zones, laser power and speed.

Certain embodiments of the system utilize a NEMA (National Electrical or Electromatic Manufacturers Association) 4× stainless steel design and are generally housed in a stainless steel enclosure suitable for wash down environments. This is important since in many processing plants the humidity and temperature are high allowing for undesirable condensation and/or deposition to build up on the enclosure or housing. The controls cabinet may be washed down during operation. The laser head however typically should be “off” and the laser beam opening provided by a shutter system closed for wash down.

Certain embodiments of the system for controlling foaming are desirably low maintenance and can provide several years of continuous operation. A supervisory control option can also be provided, as required or desired.

Certain embodiments of the system for controlling foaming are designed for the control, reduction and/or prevention of foam in aqueous and non-aqueous solutions and liquids without the need for undesirable chemical additives. In some embodiments, this is accomplished by the marriage of modem servo technology and mature infrared laser technology using a unique and specially configured foam busting controls algorithm. The user can choose from a plurality of beam scanning (cutting) patterns (e.g. up to four or more patterns) which provide effectiveness in a large variety of foam generation situations. A plurality of different zones (e.g. three or more) can be independently defined to allow for odd tank geometries. The speed of the beam scans and power levels are also programmable, giving the flexibility to handle product changeovers using, for example, a touch screen front panel which is interfaced with a system computer.

Certain embodiments of the system for controlling foaming are configured for open tank applications. Other embodiments are designed for closed or “lidded” tanks, as required or desired. In one embodiment, the laser head is connected to the controls enclosure via a flexible duct (e.g. 4 inches diameter) that carries the electronic controls signals, the laser power cable, and the cooling water lines (for cooling the laser). This duct, in some embodiments, also doubles as a forced air duct carrying conditioned air used for purging the laser head enclosure thereby desirably preventing moisture from contaminating the laser optics. An enclosure shutter system, which in some embodiments is integral, automatically closes in the event of power failure, error condition, or shutdown.

Controlling foaming systems and methods in accordance with various embodiments of the invention are applicable in a wide variety of fields including processing of organic and inorganic matter. These include, without limitation, agricultural goods and products such as food product processing to produce canned, frozen and bottled food and liquids, fermentation processes to produce, for example, beer from barley and malt.

Examples of specific products include, but are not limited to, potatoes, tomatoes, peas, spinach, broccoli, onions, apples, pineapples, chili, soups, water, milk, juices (fruits and vegetables), sugar from beet juice, chocolate from liquid cocoa mass, honey, syrups such as corn, and oil (vegetable, corn, olive, soybean, and the like), among others.

Further examples include, but are not limited to, pharmaceuticals, personal care products, household products, chemical, biological and microbiological reagents and products, general industrial products, petroleum products, forestry industry processing products, textile dyeing and processing products, pulp and paper processing products, wastewater treatment. Foaming may be controlled during any of the steps during the processing, that is, not only at the step of producing the final product but during any of the steps of producing or processing the by-products.

Certain embodiments of the invention provide processes, methods and apparatuses to control and/or reduce foam in aqueous or non-aqueous environments where foam develops during processing. One example of where foam develops is food processing. The mixture of water and solids during food processing often produces foam. Further agitation and/or heating increase the occurrence of undesirable and troublesome foam. Certain embodiments of the invention are uniquely arranged and configured to reduce and control foam during, for example, such food processing. Certain embodiments of the invention are specially designed to be adaptable to various tank, vat or chamber geometries.

In one embodiment, the system for controlling foaming is suspended a distance z above the vat or vessel in which foam is to be controlled. The geometry of the vessel in which foam is to be controlled is taught to a computer system or the like as the minimum and maximum, in one embodiment, of both the θₓ and θ_{y} angles. For example, a standard circular or rectangular geometry is then selected. In one embodiment, the laser power is set to approximately 80 Watts average power, using a square wave pulse having a duration of approximately 0.8 microseconds (μsecs) and repeated about every 1 kHz. The laser scans predefined patterns that are optionally selected by the operator to produce the required or desired results. The scan rate, in one embodiment, is approximately 50 centimeters per second. For a given foam constitution, the rate of the scan is optimized for maximum foam reduction.

As a laser, in one embodiment, scans over the foam, the electromagnetic or light energy is absorbed by the bubble membrane, disrupting surface tension. The pulsing of the light energy further disrupts the bubble membrane by the abrupt temperature changes on the surface. In one embodiment, a lens system comprises a beam expander and is used to expand the laser's output diameter to a larger collimated beam. A collimated beam is desirably used since the path length to the foam varies over the scan. This allows for consistent beam intensity throughout the scan.

The beam's waist or diameter can advantageously be adjusted to accommodate various heights per situation, as needed or desired. In one embodiment, the ‘collimated’ portion of the beam is centered to the region of interest. In another embodiment, the beam is focused to the solution or liquid level and the converging beam is allowed to attack the higher level of foam.

Various zones can be taught to the laser system to cover areas that build more foam. This typically occurs where agitation is present in the manufacturing system. The alternate scanning zones can reduce foam that concentrates in, for example, the corner of a square tank.

In one embodiment, the system for controlling foaming generally comprises an industrial CO₂ laser which operates at about 80 Watts (average power) in a pulse mode at about 100 Hz, a galvanometer x-y scanning system (scanner), and a computer interface (PC). Software controls, among other things, the laser energy output level and the rate of scanning as well as the beam patterns the scanner passes over the aqueous or non-aqueous foam. As noted above, and as also discussed below, the area covered by the system for controlling foaming is, in one embodiment, generally defined by the maximum angles θₓ and θ_{y} and the distance z between the scanning system to the foam being treated. In some embodiments, at the start of the process, the extremes of travel can either be recalled from memory or can be re-taught. Sub zones can be taught to cover areas where higher concentrations of foam develop, as required or desired. For each zone a selection of scan geometries can be selected.

The basis system operation, in accordance with some embodiments which comprise a laser and a beam scanner, can be described as follows. The laser beam is expanded to a predetermined size (e.g. a beam size of approximately 8 millimeter diameter). An x-y scanning galvanometer (scanner) is placed in the beam path to steer the laser beam over a predefined surface where foam is exposed. By scanning the laser beam over the foam, light energy is absorbed by the bubbles disrupting surface tension in the bubbles causing them to burst. In some cases the entrapped air in the bubble is heated, expanding the bubble to the bursting point.

To control or reduce foam in an aqueous or non-aqueous solution, the foam controlling system is placed in a position to efficiently cover the entire area being treated. Although in certain applications where sufficient agitation is present, a smaller scan area can be used to effectively control, reduce or substantially eliminate foam. In some cases, with the aid of a pointing laser, the scan limits are taught for a given treatment area, and the laser power level, and scan rate then set. Once started, the system can run for a long time or substantially indefinitely during processing.

The laser pulse rate (when operating in the pulsed mode) and duty cycle are desirably optimized for maximum efficiency. In one embodiment, a 100 Hz pulse rate with a 60-70% duty cycle for a 100 Watt laser provides efficient results. Depending on the persistence of the foam being treated, advantageously, the laser system's power level and scan rate can be adjusted easily.

In one embodiment, a CO₂ laser is used because of the high rate of absorption of its radiation by most aqueous and non-aqueous foams. The wavelength of the radiation in this case is about 10.6 microns (μm) but in modified embodiments can be any other wavelength in the IR range (including, but not limited to, Near IR and Mid IR) and in some cases visible or ultra-violet (UV) light (including, but not limited to, Extreme UV, e.g., with a wavelength less than about 150 nanometer (nm)) could be used. The high absorption rate at 10.6 microns (μm) desirably permits for an economical safety shielding ability with simple polycarbonate sheets to block unwanted laser light from the work environment.

In some embodiments, a high flow purge system keeps particles and vapors from contaminating the lens and scanning mirror assemblies of the foam controlling system. This purge system advantageously is used to reduce and control humidity around the laser system, which in some embodiments is water cooled, thereby desirably lowering the dew point, and preventing undesirable condensation.

System Overview

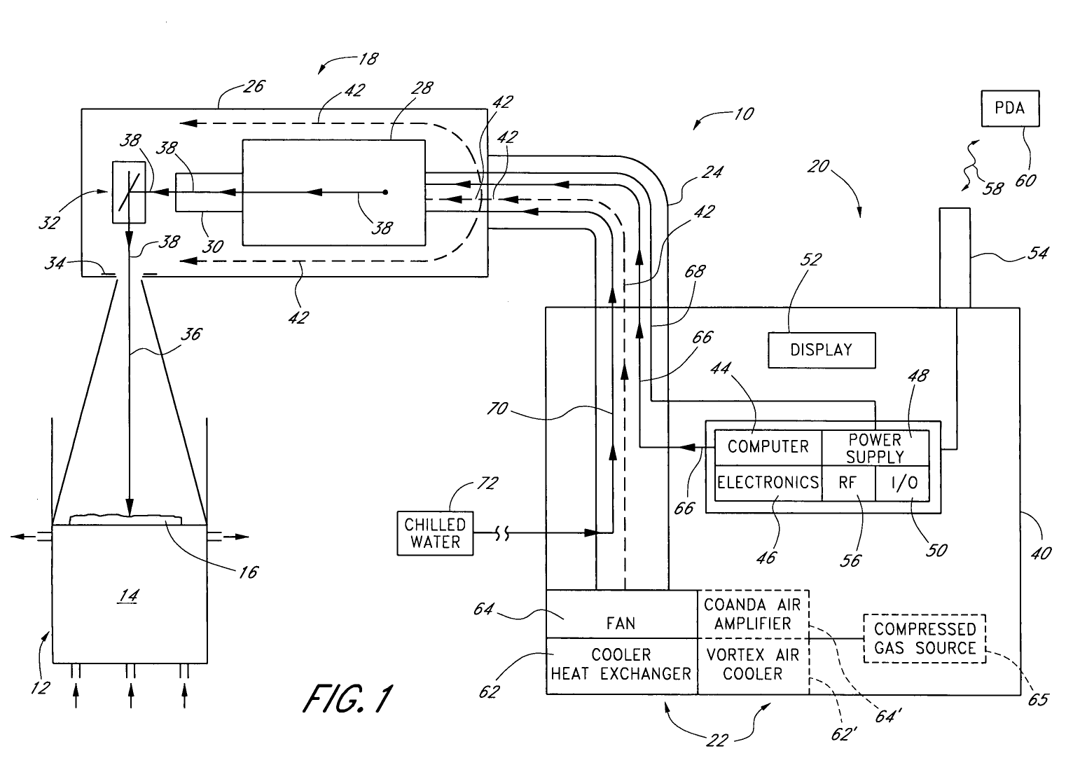

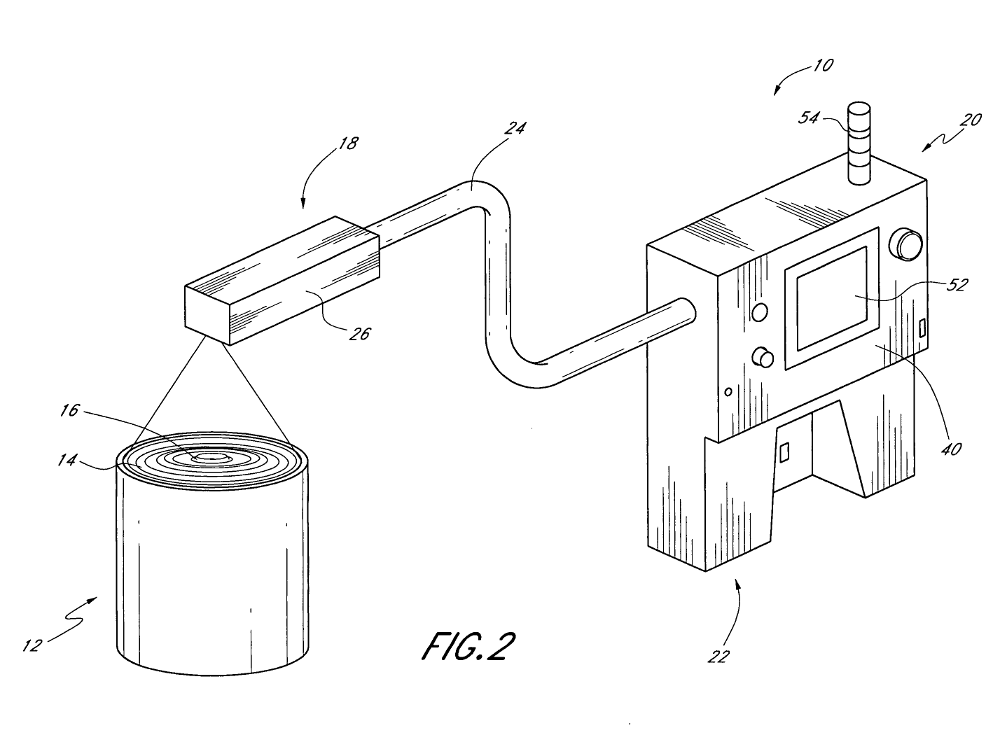

FIGS. 1 and 2 show different views of embodiments of a foam controlling system or apparatus 10. FIGS. 1 and 2 also show a tank, vat, vessel or chamber 12 that contains an aqueous or non-aqueous solution 14 and a patch of foam 16 thereon. The foam controlling system 10 may also be referred to as a defoaming system or anti-foaming system.

The foam controlling system 10 generally comprises a laser and scanning distribution system or apparatus (laser head unit) 18, a control and monitoring system or apparatus (controls enclosure or cabinet) 20 and an environment or climate control system or apparatus (source of purging fluid or air purge system) 22. A duct, pipe or conduit 24, which in one embodiment is flexible, connects the laser and scanning distribution system 18 and the environment control system 22 allowing the two to be in fluid communication.

The laser and scanning distribution system 18 generally comprises a generally outer or exterior housing 26 which houses or contains a source of electromagnetic energy or laser 28, a beam collimator, expander or lens system 30 and a beam scanning distribution system, scanning system or scanner 32. The housing 26 includes at least one shutter system 34 that is selectively opened and closed and that is generally positioned below the beam scanning system 32 (in one embodiment, an x-y galvanometer system). One of the functions of the one or more shutters 34 is to allow an electromagnetic or laser beam 36 to exit the housing 26 and be directed to the foam 16 for foam control and dissipation, as discussed further below.

An electromagnetic, light or laser beam as represented by a beam path 38 within the housing 26 originates within the laser 28 passes through the collimator 30 and is selectively deflected by the scanning system 32 through an opening of the shutter system 34 as laser beam 36 which irradiates the foam 16 to dissipate it, as discussed further below. Advantageously, the shutter system 34 is configured to automatically close in the event of power failure, error condition or shutdown.

In one embodiment, the laser head housing 26 comprises NEMA (National Electrical or Electromatic Manufacturers Association) 4× stainless steel which is advantageously suitable for wash down environments since in many plant situations vapors and solids can cause undesirable deposition and contamination. Typically, the laser 28 is “off” and the shutter system 34 is closed during wash down so that the inner components are sealed.

As discussed further below, in some embodiments, the fluid purge system 22 reduces and/or controls the dew point (and/or the temperature and humidity) within the housing 26. This is important in the situations where the laser is water cooled to a certain temperature and the system is operating in a plant where the external or ambient humidity and temperature are high. The fluid purge system 22 provides cooled, dry air to the housing 26 through the duct 24 as generally indicated by arrows 42 to prevent undesirable condensation within the housing 26. The air also serves as a positive pressure purge to reduce or substantially eliminate optics contamination.

The foam controlling system 10 including the laser and scanning system 18 can include one or more temperature and/or humidity sensors from which the dew point may be computed and monitored. External temperature and/or humidity sensors may be used to compute and monitor the external and/or plant dew point, as needed or desired. All this may be interfaced with the control and monitoring system 20 with efficacy, as required or desired.

The control and monitoring system 20 is used to control and monitor the operation of the various system components such as the laser 28, the scanner 32, the shutter system 34, the fluid purge system 22, any sensors such as temperature and/or humidity sensors, any valves, among other system components, as required or desired. The control and monitoring system 20 sends command signals as input by an operator and/or as computed by the system and receives output signals for monitoring and processing to optimize processing and facilitate automatic and safe performance.

The control and monitoring system 20 generally comprises a generally outer or exterior housing or cabinet 40 which encloses a computer or microprocessor 44, electronics 46, a power supply 48 and input/output (I/O) channels and/or ports 50. The power supply 48 may be a central power supply which can supply power to the various system components such as the laser 28 or more than one power supply may be used, as required or desired. The control and monitoring system 20 also comprises a touch screen front panel or display 52 that an operator may use to program the system.

In one embodiment, the control and monitoring system (controls cabinet) 20 comprises an antenna 54 and encloses a radio frequency (RF) transmitter/receiver 56 or the like to allow wireless signal(s) 58 communication between a personal digital assistant (PDA) or other hand held wireless device 60 or the like and the computer 44. This may be in combination with the display 52 or as an alternative, as required or desired.

In one embodiment, housing 40 comprises NEMA (National Electrical or Electromatic Manufacturers Association) 4× stainless steel. Advantageously, this allows the controls cabinet 20 (including the housing 40) to be suitable for wash down environments since in many plant situations vapors can solidify and cause undesirable deposition and contamination. The controls cabinet 20 can be washed down during operation with the inner components sealed therein.

The housing 40 can also include various switches and/or buttons on its outer surface that are easily manually accessible to an operator or user. These may include system on-off switches, emergency shut-off switches and the like, among others.

The fluid purge system 22 is shown to be enclosed within the housing 40 which desirably adds to the compactness of the system. However, in modified embodiments, at least part of the fluid purge or air conditioning system 22 may be located outside the housing 40 with efficacy, as required or desired. For example, a house or plant air conditioning system may be utilized instead and the system 10 may be configured to allow connection to such a house or plant system.

The laser head environment/climate control and/or fluid purging system 22 can be considered similar to an air conditioner that provides cool (and/or dry air). In one embodiment, the system 22 generally comprises a cooler or heat exchanger 62 (e.g. water cooled) in fluid communication with a fan 64. In another embodiment, instead of the cooler or heat exchanger 62 and fan 64, the system 22 comprises (shown in phantom) one or more vortex type air coolers 62′ and/or one or more coanda effect air amplifiers 64′ which are powered by a compressed gas source 65. The cooler or heat exchanger 62 and/or fan 64 may also be powered by the compresses gas source 65 or the like, as needed or desired.

As discussed further below, in accordance with some embodiments, the system 22 reduces and/or controls dew point within the laser head unit 18 by supplying conditioned, purging, fluid, gas or air through the duct 24 as generally indicated by arrows 42 to reduce or substantially eliminate undesirable condensation which could adversely affect optics within the laser head 18. The purging fluid, in some embodiments, desirably also provides a positive pressure purge through the laser housing 26 to reduce or substantially eliminate optics contamination.

In one embodiment, the duct 24 passes into the housing 40 of the control system 20 though in modified embodiments it does not necessarily have to. Desirably, the duct 24 is flexible which allows adaptability in relative positioning between the laser head 18 and the controls cabinet 20. In one embodiment, the duct 24 has a size or diameter of about 10 centimeters (4 inches), though in modified embodiments other suitable sizes may be efficaciously used, as required or desired.

As noted above and also discussed further below, the duct 24 serves as a mechanical shaft for flow and allows conditioned air and/or purging fluid to be provided to the laser head enclosure 26. In a modified embodiment, the duct 24 allows conditioned air and/or purging fluid to be provided to the laser head enclosure 26 through a line that passes through the duct 24. In some embodiments, an electronic control signals line 66, a laser power cable 68, and laser cooling water lines 70 also pass through the duct 24.

The electronic control signals line 66 provides input control signal commands and receives output signals from the various system components thus allowing communication with the computer 44. These components include, but are not limited to, the laser 28, the scanner 32, the shutter system 34, the fluid purge system 22, any sensors such as temperature and/or humidity sensors, any valves, among other system components.

The laser power cable 68 provides the appropriate power to the laser 28. This can be set or programmed by the user or operator, pre-programmed, or self taught or learned by the system itself, as needed or desired.

In some embodiments, the source of electromagnetic radiation or the laser 28 is cooled so that it does not over-heat and operates at a certain temperature or within a certain temperature range. One or more cooling lines 70 keep the laser 28 at this temperature or temperature range. Desirably, a chilled or cooled water source 72 is provided by controlling and regulating plant-chilled water or by using a dedicated recirculating chiller. In modified embodiments, other laser cooling sources may be used with efficacy, as needed or desired.

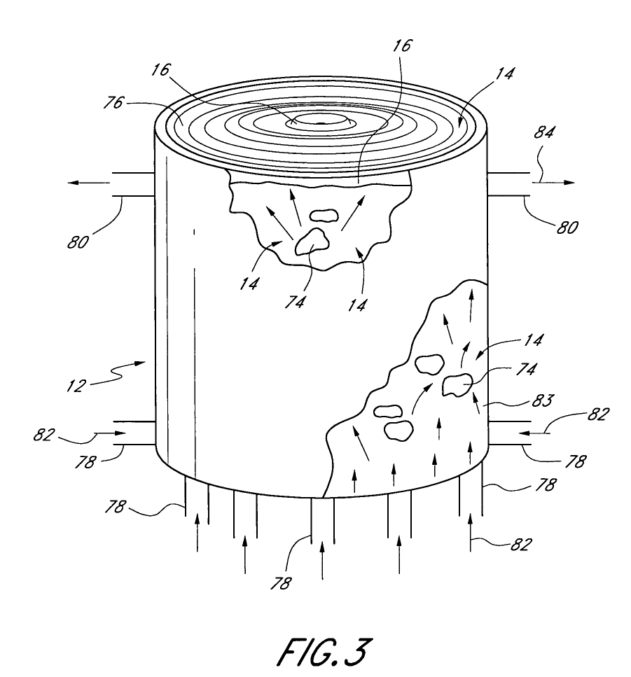

FIG. 3 shows the processing tank, vat, vessel or chamber 12 containing the aqueous or non-aqueous solution or liquid (e.g. water) 14 with solid matter 74 (e.g. an organic matter which could be an agricultural product such as, but not limited to, potatoes). A top or upper surface 76 of the solution 14 has foam 16 formed thereon.

The tank 12 can have various shapes and configurations such as round, rectangular, among others. As discussed further below, the tank 12 has fluid flow dynamics which can be at least one reason for the formation of foam 16. As also discussed further below, agitation, fluid flow currents and chemical reactions are also at least partially responsible for foam formation. Certain embodiments of the invention, as described further below, control and/or reduce the foam 16.

In many instances, the tank 12 is in a plant or manufacturing setting where multiple processes are being performed. In some embodiments, the tank 12, and more particularly the solution 14 being processed in the tank 12 emits vapor or steam. Other processes in the plant may also emit vapor or steam. This can cause the humidity (and/or temperature) of the ambient conditions to rise. Accordingly, as noted above, and as also discussed further below, the dew point in the laser head 18 is reduced and/or controlled to prevent or substantially eliminate undesirable condensation which can contaminate the system optics.

The tank 12 has one or more fluid inlets 78 and one or more fluid outlets 80. In one embodiment, one or more liquids 82 (or solutions) flow into the tank 12 and one or more liquids (or solutions) 84 flow out of the rank 12. Various screens, porous plates, diffusers, distributors, manifolds, plenums, valves and the like, among others, may be used in conjunction with the tank 12 to provide the appropriate processing condition, as required or desired. Various flow rates (for example, but not limited to, 4,000 gallons per minute (GPM)), inflow pressures, temperature conditions and the like, among others, may be set with efficacy, as needed or desired, depending on the particular process.

As noted above, the solids 74 may include organic and/or inorganic matter. In some embodiments, one or more different solids 74 can be processed in the tank 12 at the same time. In some embodiments, one or more different liquids (or solutions) 83 may be present in the tank 12. In some embodiments, only one or more different liquids (or solutions) 83 may be present in the tank 12 without any solids. In some embodiments, there may be no flow inlets and/or outlets in association with the tank 12 and foam 16 may be created by other sources of agitation and sources which create fluid flow currents (e.g. impellers, nozzles, baffles, paddles, rotating vanes and the like, among others) or simply by chemical reactions (e.g. a reaction between two or more fluids or liquids in the tank, heating, among others).

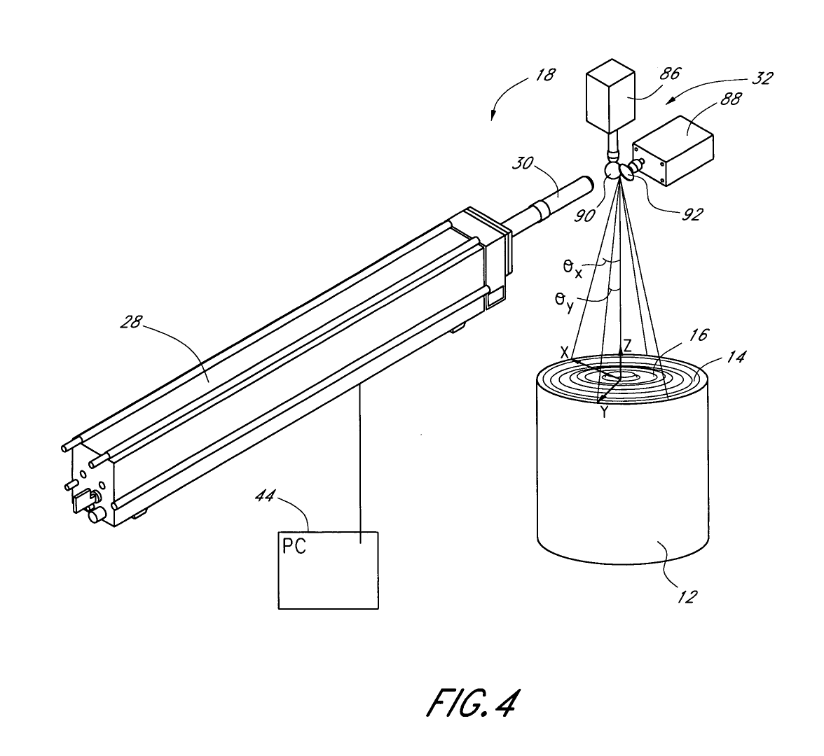

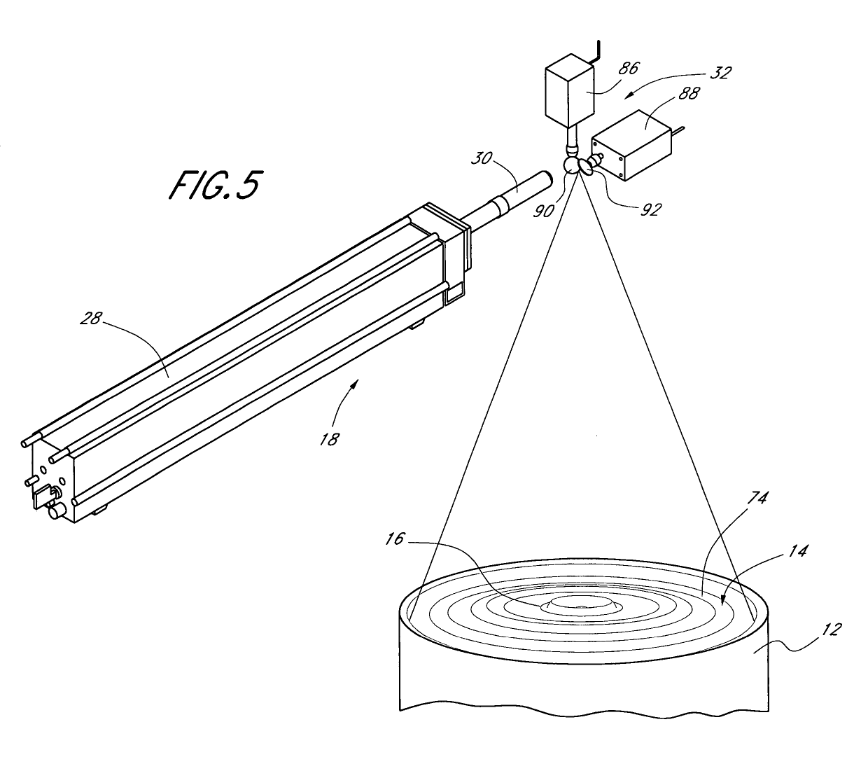

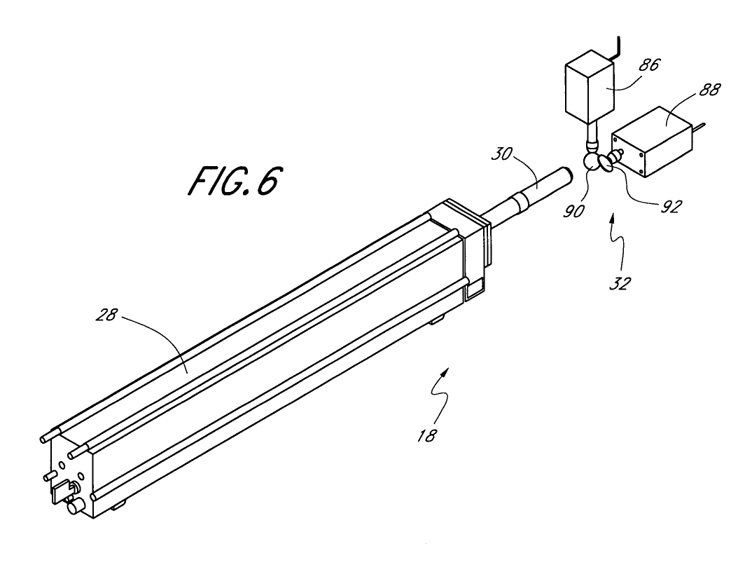

FIGS. 4, 5 and 6 show different views of embodiments of the laser and scanning distribution system 18 (for clarity, the enclosure 26 is not shown in these drawings). These drawings generally show the laser 28, the collimator or lens system 30 and the scanning system 22. The system 18 can also comprise other optical devices, lenses, mirrors, filters and the like, among other devices, with efficacy, as needed or desired. TABLE 1 below shows specifications of two exemplary embodiments of the foaming control system 10.

TABLE 1
EXEMPLARY EMBODIMENTS OF FOAM CONTROLLING SYSTEM

| | First Exemplary | Second Exemplary |
|---|---|---|
| Parameter | Embodiment | Embodiment |
| Laser | | |
| Output power | | |
| Continuous | 100 Watts | 200 Watts |
| Pulsed | 150 Watts | 250 Watts |
| Modulation | Up to 10 KHz - programmable | |
| Duty Cycle | 0-100% programmable | |
| Beam Diameter (Adjustable) | 4-8 millimeters | |
| Scan Angle (both x and y axis) | ±30° | |
| Scan Dimension (diameter) | 1.1 times the height of laser head above process | |
| Mechanical | | |
| Laser head unit | | |
| Dimensions | 47″ L × 9″ W × 7.1″ H | 51″ L × 15.5″ W × 8.4″ H |
| Weight | 80 lbs | 120 lbs |
| Controls Enclosure | | |
| Dimensions | 36″ W × 48″ H × 12″ DP | |
| Weight | 150 lbs | |
| Typical Services | | |
| Electrical | 200-240 VAC single-phase | 200-240 VAC three-phase |
| | (1φ), with grounded | (3φ), with grounded |
| | conductor (N) and ground - | conductor (N) and ground - |
| | 30 Amperes | 20 Amperes |
| Laser Cooling Water | ≧2 gallons per minute (GPM) | ≧5 gallons per minute (GPM) |
| (Provided by controlling and | @ <60 pounds per square | @ <60 pounds per square |
| regulating plant-chilled | inch (psi) | inch (psi) |
| water or by using a dedicated | | |
| recirculating chiller.) | | |
| Heat Load | 1800 Watts | 3600 Watts |

| | |
|---|---|
| Temperature | 20 ± 2° C., 68 ± 5° F. |
| Pneumatic | Compressed air ≧40 pounds per square inch (psi) |
| Safety | Interlocked barrier, plexiglass shield and/or safety glasses |
| (This is considered a Class | |
| IV installation per ANSI | |
| Z136.1 Standard for the Safe | |
| Use of Lasers.) | |

The laser 28 desirably comprises an industrial laser that is robust and can operate substantially continuously over long periods of time (e.g. in some cases, on the order of years). In one embodiment, the laser 28 comprises an industrial CO₂ laser which generates electromagnetic radiation in the infrared regime with a with a wavelength of about 10.6 microns (μm).

In one embodiment, the laser 28 is operated in a continuous mode and in another embodiment the laser 28 is operated in a pulsed mode, as needed or required. The frequency can be modulated and is desirably programmable, as needed or desired. The duty cycle is also advantageously programmable, as needed or desired.

In some embodiments, the laser 28 is water cooled so that it operates at a certain temperature or temperature range to prevent undesirable overheating. In one embodiment, the laser temperature is about 20±2° C. (68±5° F.), including all values and sub-ranges therebetween. In modified embodiments, other suitable laser temperatures may be efficaciously utilized, as required or desired.

As noted above, and as discussed further below, the water cooled laser 28 is in some cases operated in plants where the ambient humidity (and/or temperature) is high which can cause undesirable condensation and lead to contamination of the laser optics. Accordingly, in some embodiments, the air conditioning system reduces and/or controls the dew point within the laser head enclosure 26.

The lens system or beam collimator 30 serves to adjust the laser beam diameter. It is generally used as a beam diameter expander but may also be used as beam diameter reducer, for example, to focus the beam, as needed or desired. The lens system 30 can also facilitate in improving the parallelness of rays within the beam.

One reason a collimated beam is desirably used is because the path length to the foam 16 varies over the scan. The collimated beam advantageously allows for consistent beam intensity throughout the scan.

In one embodiment, the collimator 30 generates a beam with a diameter of about 6 millimeter (mm). In another embodiment, the collimator 30 generates a beam with a diameter in the range from about 4 millimeter (mm) to about 8 millimeter (mm), including all values and sub-ranges therebetween. In modified embodiments, other suitable beam diameters may be efficaciously utilized, as required or desired.

The scanning system 32 generally comprises a galvanometer system which comprises a pair of galvanometers 86, 88 coupled to a pair of movable or rotatable adjustable mirrors 90, 92. In one embodiment, the galvanometer is an x-y galvanometer system though in modified embodiments other coordinate systems may be utilized with efficacy, needed or desired. The galvanometers 86, 88 control the angulation of respective mirrors 90, 92 so as to direct the laser beam 38 at the desired location on the foam 16.

As noted above, the area covered by the system for controlling foaming, in one embodiment, is generally defined by the maximum angles θₓ and θ_{y} and the distance “z” between the scanning system to the foam being treated. For a given tank geometry or perimeter, the maximum beam range or span can be defined by the maximum deflection angles to reach the tank diameter or perimeter in two arbitrary planes generally perpendicular to the surface of the solution 14 (or alternatively, along two arbitrary axes along the surface of the solution 14). In certain embodiments these two planes are perpendicular to one another and the maximum deflection angles are referred to as the maximum beam scan angles θₓ and θ_{y}. The distance “z” can be generally defined as the vertical distance between the scanner 32 and the foam 16.

In one embodiment, the maximum beam scan angles θₓ and θ_{y} are ±30° (or 60°). In modified embodiments, other suitable maximum beam scan angles may be used with efficacy, as needed or desired.

Beam Scan Patterns and System Operation

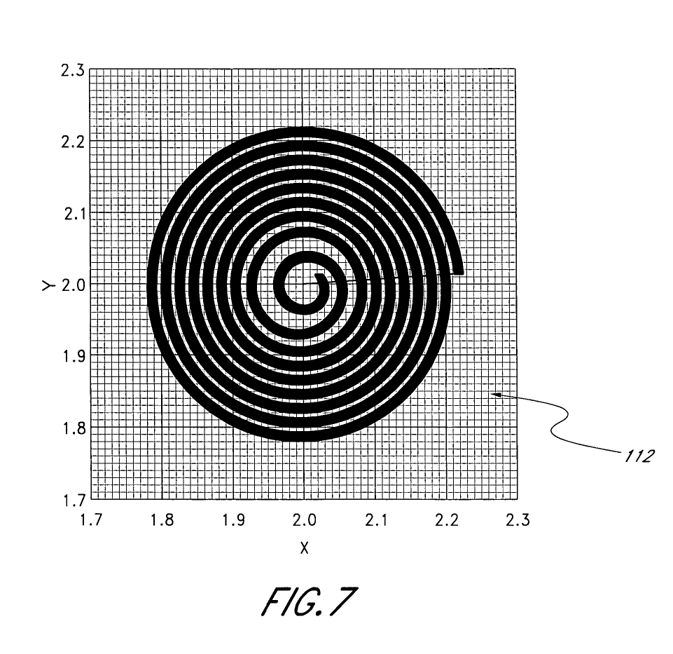

FIG. 7 shows one embodiment of a spiral beam pattern 112 that cuts the patch of foam 16 into a plurality (at least two) portions such that at least one of the portions is dissipated, as discussed further below. Also as discussed further below, the spiral beam pattern 112 can be used to dissipate foam that forms in a generally stagnant area at or proximate a corner or perimeter of the tank 12.

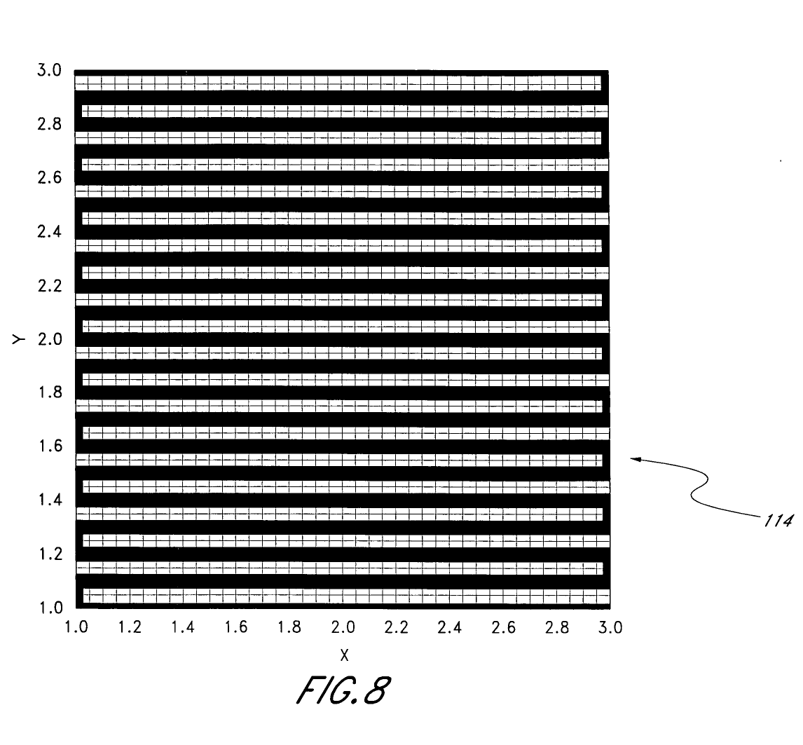

FIG. 8 shows one embodiment of a raster beam pattern 114 that cuts the patch of foam 16 into a plurality (at least two) portions such that at least one of the portions is dissipated, as discussed further below. Also as discussed further below, the raster beam pattern 114 can be used to dissipate foam that forms in a generally stagnant area at or proximate a corner or perimeter of the tank 12.

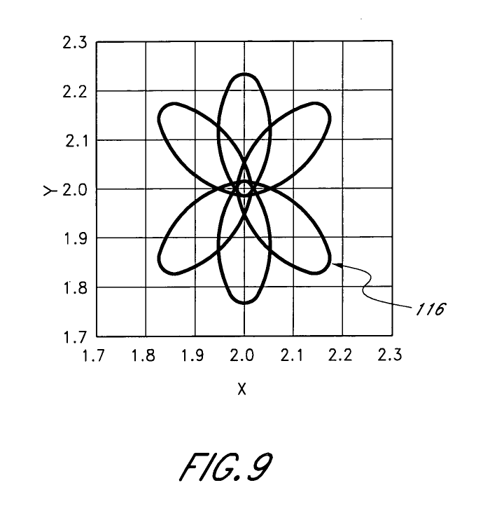

FIG. 9 shows one embodiment of a petal beam pattern 116 that cuts the patch of foam 16 into a plurality (at least two) portions such that at least one of the portions is dissipated, as discussed further below. Also as discussed further below, the petal beam pattern 116 can be used to dissipate foam that forms in a generally stagnant area at or proximate a corner or perimeter of the tank 12.

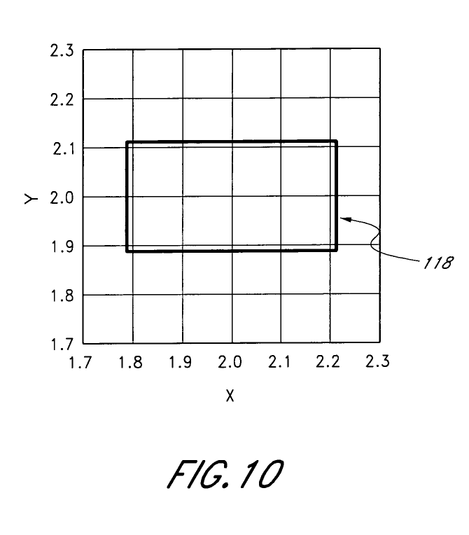

FIG. 10 shows one embodiment of a rectangular (or square) beam pattern 118 that cuts the patch of foam 16 into a plurality (at least two) portions such that at least one of the portions is dissipated, as discussed further below. Also as discussed further below, the rectangular beam pattern 118 can be used to dissipate foam that forms in a generally stagnant area at or proximate a corner or perimeter of the tank 12.

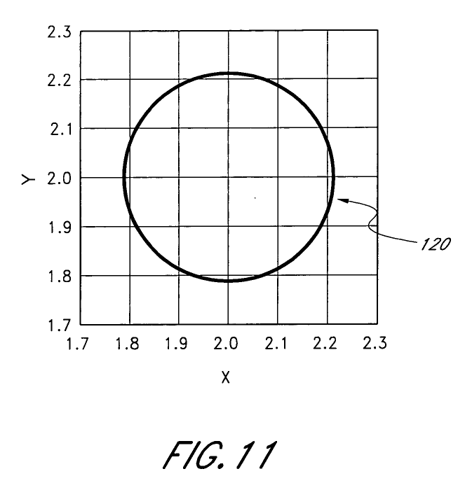

FIG. 11 shows one embodiment of a circular beam pattern 120 that cuts the patch of foam 16 into a plurality (at least two) portions such that at least one of the portions is dissipated, as discussed further below. Also as discussed further below, the circular beam pattern 120 can be used to dissipate foam that forms in a generally stagnant area at or proximate a corner or perimeter of the tank 12. In modified embodiments, an ellipsoidal or elliptical beam pattern can be used with efficacy, as needed or desired.

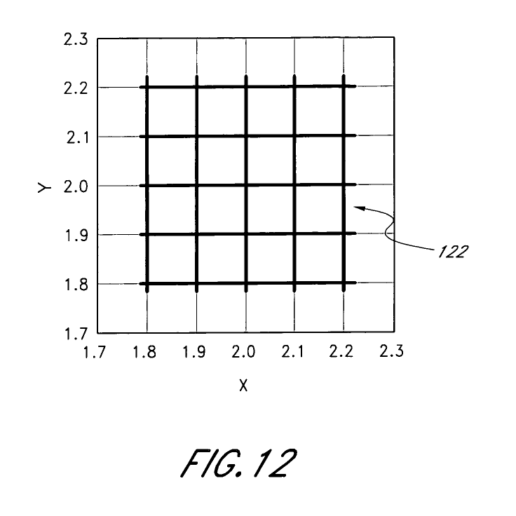

FIG. 12 shows one embodiment of a toggled (alternating) beam pattern 122 that cuts the patch of foam 16 into a plurality (at least two) portions such that at least one of the portions is dissipated, as discussed further below. Also as discussed further below, the toggled beam pattern 122 can be used to dissipate foam that forms in a generally stagnant area at or proximate a corner or perimeter of the tank 12.

In one embodiment, the toggled beam pattern 122 comprises a combined x-y alternating pattern. In another embodiment, the toggled beam pattern 122 comprises only an x-axis alternating pattern. In yet another embodiment, the toggled beam pattern 122 comprises only a y-axis alternating pattern. In modified embodiments, toggled beam patterns in other coordinate systems may be efficaciously used, as needed or desired.

In further modified embodiments, other beam patterns, for example, but not limited to, zigzag, sinusoidal and the like, other polygonal and/or non-polygonal configurations, and any combinations and superimpositions of any of the beam patterns disclosed, taught or suggested herein may be utilized with efficacy, as required or desired. Any of the patterns may be repeated with the same, smaller or larger size with efficacy, as required or desired.

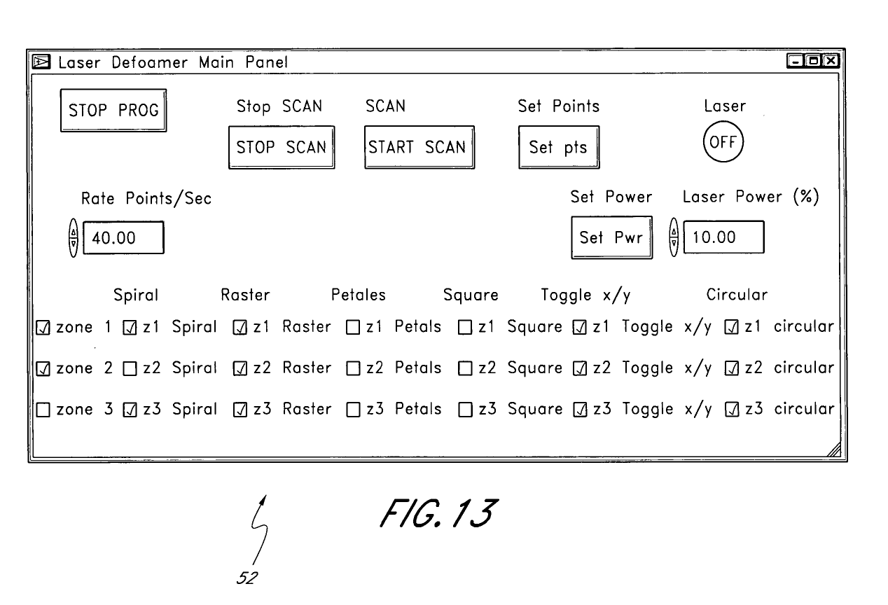

FIG. 13 shows one embodiment of the control panel or display 52 of the control and monitoring system 20 which desirably provides a computer interface. In one embodiment, the panel or display 52 comprises a touch screen front panel or display. In one embodiment, the panel or display 52 is provided on the PDA or other hand held wireless device 60.

The panel 52 can provide a wide variety of features for the operator or user. These include, without limitation, laser on-off, start-stop program/algorithm, set laser power, set points, rate points/sec, start and stop scan, select zone or zones (span or range), select beam pattern(s) for cutting foam, among others.

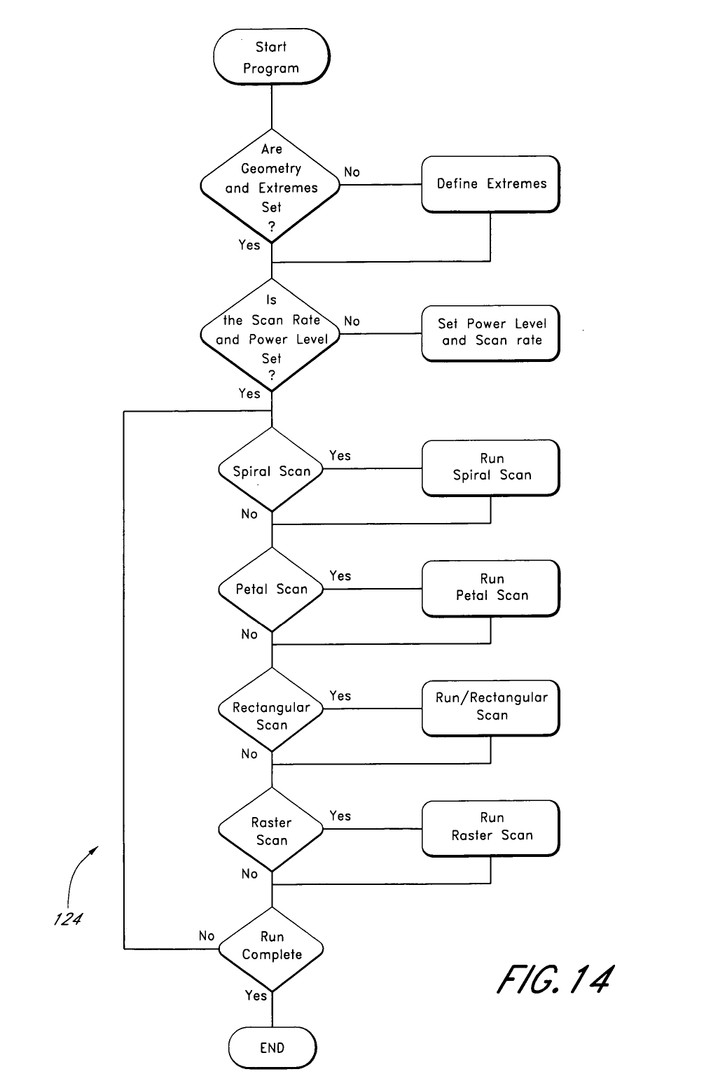

FIG. 14 shows one embodiment of a flow chart or algorithm 124 for controlling the control and monitoring system 20 which illustrates a simplified program of system operation. The flow chart or algorithm 124 can provide a wide variety of features programmable features that may be implemented in the system software. These include, without limitation, start program, set geometry and extremes for laser scanning, set scan rate and laser power levels, select beam pattern for cutting foam, repeat with same or different beam pattern, change geometry and extremes and change scan rate and laser power level, among others.

Various other features can be efficaciously utilized in conjunction with the computer interfaced panel 52 and/or the flow chart (software) 124. These features include, but are not limited to operating the laser in a continuous or pulsed mode; selecting and/or computing the frequency and duty cycle; selecting and/or computing the beam diameter and maximum scan angles; detecting, cutting and dissipating foam at one or more relatively stagnant regions at or adjacent a corner or sides of the processing tank 12; controlling and monitoring the shutter system 34; controlling and monitoring the scanning system 32; controlling and monitoring the internal environment control system 22 (air conditioning system); controlling and monitoring the temperature and humidity sensors (internal and plant); computing and monitoring dew point (internal and plant); switching to remote or wireless mode as and when needed or desired; controlling and monitoring chilled water flow to the laser 28; controlling and monitoring various valves, flow rates and the like; controlling emergency shut-down; providing warning signals just prior to an emergency shut-down; and providing visual images of the foam dissipation process via a camera or the like, as needed or desired, among various other control, monitoring, display and computational features.

Foam Formation and Dissipation

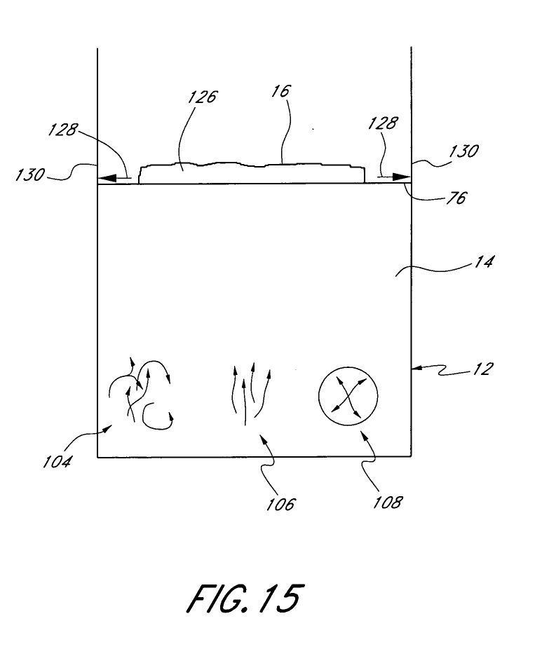

FIG. 15 shows some embodiments of the formation and propagation of the patch of foam 16 as a layer 126 on the surface 76 of the aqueous or non-aqueous solution or liquid 14. The provided tank 12 contains the aqueous or non-aqueous solution or liquid 14 which generates the foam 16. The tank 12 has fluid flow dynamics which cause the foam generated by aqueous or non-aqueous solution or liquid 14 to form a patch of foam 16 which increases in size so as to propagate foam 16 in the form of the layer 126 on the surface of the aqueous or non-aqueous solution or liquid 14 towards a perimeter 130 of the tank 12. The direction of propagation of the foam layer 126 towards the tank perimeter 130 is generally denoted by arrows 128.

As used herein, the terminology “fluid flow dynamics” of the tank 12 is a broad term which includes its common definition and which encompasses a wide variety of features and activities which may be directly and/or indirectly associated with the tank 12 as long as these features and activities are associated with the creation or dissipation of foam.

The tank fluid flow dynamics can include the tank size, geometry and/or shape. For example, but without limitation, the tank 12 may be round, rectangular, or may have other polygonal or non-polygonal shapes and/or cross-sections. Tapered or varying cross-sections or perimeters may also be utilized with efficacy, as needed or desired. In some embodiments, agitation, fluid flow currents and/or chemical reaction(s) in the aqueous or non-aqueous solution or liquid 14 are at least partially responsible for the creation or dissipation of the foam 16.

The tank fluid flow dynamics can also be related to, for example, but not limited to, the size, positioning and number of flow inlets 78 and outlets 80; whether the inlets 78 and outlets 80, and in particular the inlet portion, utilize screens, porous plates, diffusers, distributors, manifolds, plenums and the like to create a certain flow patterns; the flow rates, inflow and/or outflow pressures and temperatures; and global and local laminar and turbulent flow conditions, among other things.

The tank fluid flow dynamics can also be related to, for example, but not limited to, the fluid characteristics and properties of the solution or liquid 14 in the processing tank 12. This relates to the fluid characteristics and properties of the liquid(s) 83 and whether the tank 12 contains only liquid(s) or a liquid(s)-solid(s) solution; and relates to the characteristics, properties, density and distribution of the solid(s) 74 in the processing tank 12. Other features, characteristics and properties of the solution or liquid 14 may also contribute to the tank fluid flow dynamics.

In one embodiment, the foam 16 is generated by agitation 104 in the processing tank 12. Sources of agitation 104 can include, without limitation, fluid flow currents or chemical reaction(s) within the tank 12. Other examples of agitation 104 are impellers, nozzles, baffles, paddles, rotating vanes, brackets and the like, among others. The agitation 104 can also be caused by local (and/or global) turbulent flow(s) caused by the liquid 83 flowing over and around the solids 74 in the processing tank 12.

In one embodiment, the foam 16 is generated by fluid flow currents 106 in the processing tank 12. Sources of fluid flow currents 106 can include, without limitation, liquid 82 flowing into the tank 12 or chemical reaction(s) within the tank 12. Other examples that can create fluid flow currents 106 are impellers, nozzles, baffles, paddles, rotating vanes, brackets and the like, among others. Fluid flow currents 106 can also be caused by local (and/or global) turbulent flow(s) caused by the liquid 83 flowing over and around the solids 74 in the processing tank 12.

In one embodiment, the foam 16 is generated by chemical reaction(s) 108 in the processing tank 12. The chemical reaction(s) can release energy and cause foam generation, for example, by agitation and/or creation of fluid flow currents. For instance one or more reactions between one or more fluids, liquids and/or solids in the tank 12 can release energy and can cause foam generation. Other examples are fermentation and heating which can cause foam generation.

The foam 16 may not be created because of only one particular activity of source. One or more different sources or activities as taught, disclosed or suggested herein and as known in the art may be responsible for foam generation.

The foam 16 generally comprises a plurality or agglomeration of gaseous bubbles with liquid walls or boundaries. The bubbles can form below the top surface 76 of the solution or liquid 14 and rise due to buoyancy and gather together to form one or more patches of foam 16. The foam 16 may also comprise some solid material in the form of surfactants or the like.

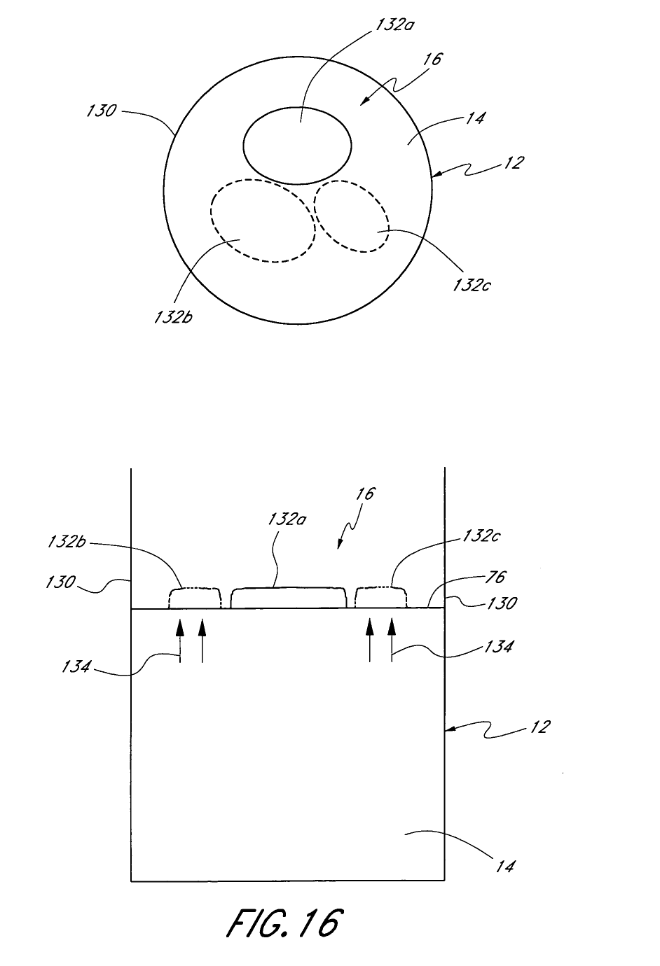

FIG. 16 shows one embodiment of cutting the patch of foam 16 into a plurality (at least two) portions 132 (132a, 132b, 132c) by the system for controlling foaming 10 and dissipation of at least one of the portions 132b, 132c (shown in phantom or dashed lines). In one embodiment, a process or method for controlling foaming generally comprises cutting the foam 16 into at least two portions 132 prior to the propagating layer 126 reaching substantially the entire perimeter 130 of the tank 12, such that currents 134 within the solution or liquid 14 dissipate at least one of the portions 132 of foam 16.

In one embodiment, the foam 16 is cut by the electromagnetic or laser beam 36 from the top, down to the surface 76 of the solution or liquid 14. In another embodiment, the foam 16 is cut by the electromagnetic or laser beam 36 at an angle, down to the surface 76 of the solution or liquid 14.

Any of the beam patterns taught, disclosed or suggested herein, among others, may be used to cut the foam 16 into a plurality of portions 132a, 132b, 132c. These include the beam foam cutting patterns 112, 114, 116, 118, 120 and 122 taught above.

The currents 134 are able to dissipate or collapse the foam portions 132b and 132c since they are smaller in size then the patch of foam prior to cutting, and hence more susceptible to break-up. The currents can be caused by a number of sources as discussed above and herein such as agitation 104, fluid flow currents 106 and chemical reaction(s) 108, among others.

It is contemplated, that as the laser beam 36 scans over the foam 16 the electromagnetic or light radiation or energy is absorbed by the foam bubbles (and/or the bubble membranes) thereby disrupting bubble wall surface tension and causing the bubbles to burst and explode. This allows the laser scanning to cut the foam 16 in a plurality of portions 132. In some cases, the entrapped gas or air in the foam bubbles is heated by the electromagnetic or light energy, thereby expanding the bubbles to their bursting points. When the source of electromagnetic energy or radiation or laser 28 is operating in a pulsed mode, the pulsing of the light energy can further disrupt the foam bubbles or bubble membranes by the abrupt temperature changes on the surface, thereby causing bubble bursting and explosion and desirably further facilitating foam cutting.

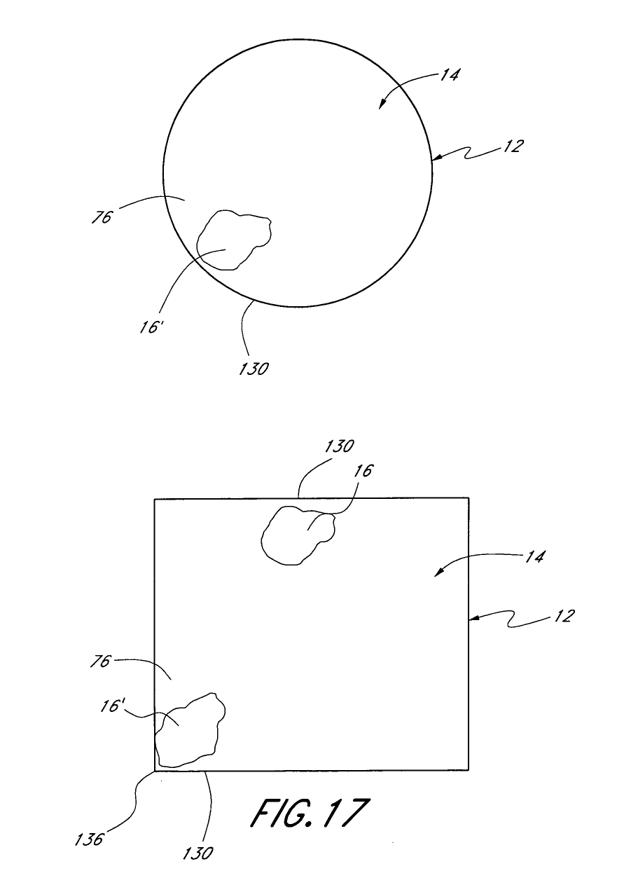

FIG. 17 shows embodiments of patches of foam 16′ that form in relatively stagnant areas on the surface 76 of the solution or liquid 14 at or near a corner 136 and/or at one or more sides or perimeter 130 of the processing tank 12.

Any of the beam patterns taught, disclosed or suggested herein, among others, may be used to cut the foam 16′ and dissipate it. These include the beam foam cutting patterns 112, 114, 116, 118, 120 and 122 taught above.

Since the relatively stagnant area on the surface 76 of the solution or liquid 14 at or near the corner 136 and/or at one or more sides or perimeter 130 of the processing tank 12 would generally be isolated from the currents 134 in the tank 12, in one embodiment, the electromagnetic or light radiation or energy of the laser beam 36 is directly used to dissipate or collapse the foam 16′. In another embodiment, the foam 16′ is cut into a plurality of portions (as discussed above and herein) and a mechanical source (e.g. impeller, nozzle, baffle, paddle, rotating vane, bracket or the like, among others) is used to dissipate the foam portions. In yet another embodiment, the foam portions migrate (or are facilitated to migrate) to an area of the tank 12 where the tank currents 134 dissipate the foam portions or at least one of the foam portions.

In some embodiments, spray nozzles are used to force the stagnant foam formation(s) 16′ into the major current flow, whereby the laser beam 36 is then used to dissipate or collapse the foam 16′ and/or facilitate in its collapse and dissipation. Use of such spray nozzles is generally controlled by a timed output within the controls algorithm. Any number of passive or active methods may be used with efficacy to corral the stagnant foam 16′ to a relatively non-stagnant region where current flow is present. These include, without limitation, liquid or gas spray nozzles, baffles, paddles, and the like, among others.

Any of the methods and processes which are described and illustrated herein are not limited to the sequence of acts described, nor are they necessarily limited to the practice of all of the acts set forth. Other sequences of acts, or less than all of the acts, or simultaneous occurrence of the acts, may be utilized in practicing embodiments of the invention.

Dew Point Control

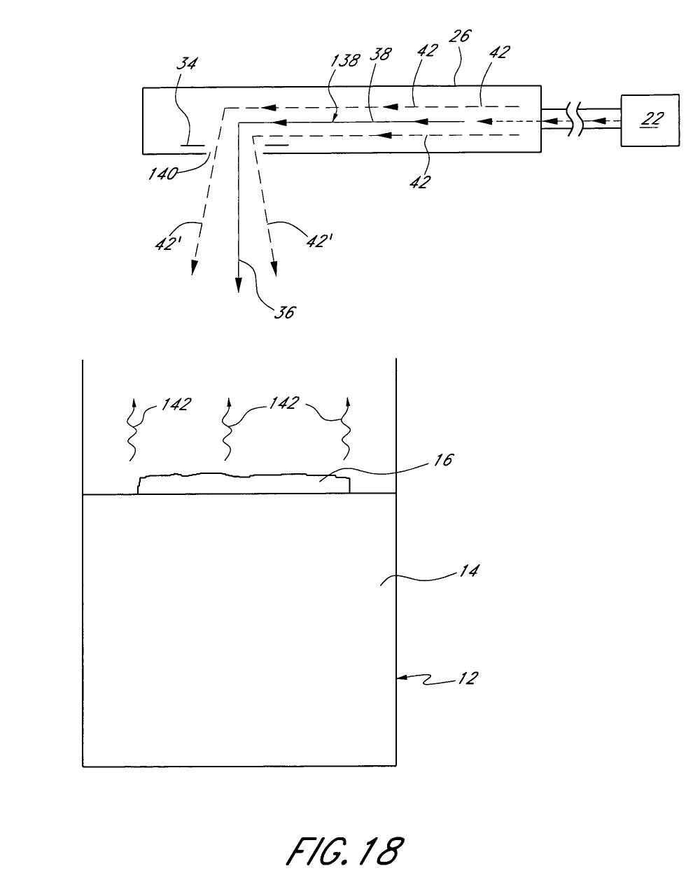

FIG. 18 shows one embodiment of reducing or controlling dew point along at least a portion of a beam path 38 of an electromagnetic or laser beam 138 by providing purging fluid or conditioned and/or cooled and/or dry air 42 within the housing 26 and out of an opening 140. For clarity, the reference numeral 38 refers to the beam path generally within the housing 26, the reference numeral 138 refers to the electromagnetic beam or radiation generally within the housing 26, the reference numeral 36 refers to the electromagnetic beam or radiation (and the beam path) generally outside the housing 26, the reference numeral 42 refers to the purging fluid or cooled and/or dry air generally within the housing 26, and the reference numeral 42′ refers to the purging fluid or cooled and/or dry air generally outside the housing 26 as it exits the opening 140.

In one embodiment, a method for controlling foaming generally comprises directing the beam of electromagnetic radiation 138 along a beam path 38 towards the foam 16 through at least a portion of the housing 26 and reducing dew point along a portion of the beam path 38 within the housing 26 by directing a flow of purging fluid 42 through at least a portion of the housing 26 and out of one or more openings 140 in the housing 26 as fluid 42′.

In one embodiment, an apparatus for controlling foaming 10 generally comprises the source of electromagnetic radiation 28 which produces the electromagnetic beam 138. The beam 138 propagates along the beam path 38 through at least a portion of the housing 26 and towards the foam 16 as beam 36. The apparatus 10 further comprises the source 22 of purging fluid 42 which provides the purging fluid 42 to the housing 26 such that dew point along a portion of the beam path 38 within the housing 26 is reduced.

By way of background, dew point is generally defined as the temperature at which condensations forms. The dew point is a function of temperature and relative humidity. When air comes in contact with a surface that is at or below its dew point temperature, condensation forms on that surface.

TABLES 2 and 3 below show how to approximately determine the dew point based on the temperature and relative humidity. To determine the dew point from TABLES 2 and 3 below, find the row corresponding to temperature of the air in question on the left side of the table. Next, locate the column corresponding to relative humidity of the air in question across the top of the table. The intersection of this row and column in the matrix identifies the temperature at which dew point is reached.

For example, if the temperature in a facility is 75° F. (24° C.) and the relative humidity is 35%, TABLE 3 shows that the dew point is reached at a temperature of 45° F. (7° C.), or below. This means that moisture vapor in the 75° F./35% relative humidity (RH) air will condense on any surface that is at or below the dew point temperature of 45° F.

TABLE 2
Dew Point in Degrees Celsius

| Air | | | | | | | | | | | | | | | | | | | |
|---|---|---|---|---|---|---|---|---|---|---|---|---|---|---|---|---|---|---|---|
| Temp | % Relative Humidity | | | | | | | | | | | | | | | | | | |
| ° C. | 100 | 95 | 90 | 85 | 80 | 75 | 70 | 65 | 60 | 55 | 50 | 45 | 40 | 35 | 30 | 25 | 20 | 15 | 10 |
| 43 | 43 | 42 | 41 | 40 | 39 | 38 | 37 | 35 | 34 | 32 | 31 | 29 | 27 | 24 | 22 | 18 | 16 | 11 | 5 |
| 41 | 41 | 39 | 38 | 37 | 36 | 35 | 34 | 33 | 32 | 29 | 28 | 27 | 24 | 22 | 19 | 17 | 13 | 8 | 3 |
| 38 | 38 | 37 | 36 | 35 | 34 | 33 | 32 | 30 | 29 | 27 | 26 | 24 | 22 | 19 | 17 | 14 | 11 | 7 | 0 |
| 35 | 35 | 34 | 33 | 32 | 31 | 30 | 29 | 27 | 26 | 24 | 23 | 21 | 19 | 17 | 15 | 12 | 9 | 4 | 0 |
| 32 | 32 | 31 | 31 | 29 | 28 | 27 | 26 | 24 | 23 | 22 | 20 | 18 | 17 | 15 | 12 | 9 | 6 | 2 | 0 |
| 29 | 29 | 28 | 27 | 27 | 26 | 24 | 23 | 22 | 21 | 19 | 18 | 16 | 14 | 12 | 10 | 7 | 3 | 0 | |
| 27 | 27 | 26 | 25 | 24 | 23 | 22 | 21 | 19 | 18 | 17 | 15 | 13 | 12 | 10 | 7 | 4 | 2 | 0 | |
| 24 | 24 | 23 | 22 | 21 | 20 | 19 | 18 | 17 | 16 | 14 | 13 | 11 | 9 | 7 | 5 | 2 | 0 | | |
| 21 | 21 | 20 | 19 | 18 | 17 | 16 | 15 | 14 | 13 | 12 | 10 | 8 | 7 | 4 | 3 | 0 | | | |
| 18 | 18 | 17 | 17 | 16 | 15 | 14 | 13 | 12 | 10 | 9 | 7 | 6 | 4 | 2 | 0 | | | | |
| 16 | 16 | 14 | 14 | 13 | 12 | 11 | 10 | 9 | 7 | 6 | 5 | 3 | 2 | 0 | | | | | |
| 13 | 13 | 12 | 11 | 10 | 9 | 8 | 7 | 6 | 4 | 3 | 2 | 1 | 0 | | | | | | |

| | | | | | | | | | | | |
|---|---|---|---|---|---|---|---|---|---|---|---|
| 10 | 10 | 9 | 8 | 7 | 7 | 6 | 4 | 3 | 2 | 1 | 0 |

| | | | | | | | | | |
|---|---|---|---|---|---|---|---|---|---|
| 7 | 7 | 6 | 6 | 4 | 4 | 3 | 2 | 1 | 0 |

| | | | | | | |
|---|---|---|---|---|---|---|
| 4 | 4 | 4 | 3 | 2 | 1 | 0 |

| | | | |
|---|---|---|---|
| 2 | 2 | 1 | 0 |

| | |
|---|---|
| 0 | 0 |

Example: Read the air temperature in the left hand column and the humidity in the top row of the chart. If the temperature of a storage unit is 75° F. (24° C.) and the relative humidity is 35%, the intersection of the two shows the dew point of the area to be 45° F. (7° C.). If a metal coming in to the unit is below 45° F. (7° C.), water will condense on the metal.

TABLE 3
Dew Point in Degrees Fahrenheit

| Air | | | | | | | | | | | | | | | | | | | |
|---|---|---|---|---|---|---|---|---|---|---|---|---|---|---|---|---|---|---|---|
| Temp | % Relative Humidity | | | | | | | | | | | | | | | | | | |
| ° F. | 100 | 95 | 90 | 85 | 80 | 75 | 70 | 65 | 60 | 55 | 50 | 45 | 40 | 35 | 30 | 25 | 20 | 15 | 10 |
| 110 | 110 | 108 | 106 | 104 | 102 | 100 | 98 | 95 | 93 | 90 | 87 | 84 | 80 | 76 | 72 | 65 | 60 | 51 | 41 |
| 105 | 105 | 103 | 101 | 99 | 97 | 95 | 93 | 91 | 88 | 85 | 83 | 80 | 76 | 72 | 67 | 62 | 55 | 47 | 37 |
| 100 | 100 | 99 | 97 | 95 | 93 | 91 | 89 | 86 | 84 | 81 | 78 | 75 | 71 | 67 | 63 | 58 | 52 | 44 | 32 |
| 95 | 95 | 93 | 92 | 90 | 88 | 86 | 84 | 81 | 79 | 76 | 73 | 70 | 67 | 63 | 59 | 54 | 48 | 40 | 32 |
| 90 | 90 | 88 | 87 | 85 | 83 | 81 | 79 | 76 | 74 | 71 | 68 | 65 | 62 | 59 | 54 | 49 | 43 | 36 | 32 |
| 85 | 85 | 83 | 81 | 80 | 78 | 76 | 74 | 72 | 69 | 67 | 64 | 61 | 58 | 54 | 50 | 45 | 38 | 32 | |
| 80 | 80 | 78 | 77 | 75 | 73 | 71 | 69 | 67 | 65 | 62 | 59 | 56 | 53 | 50 | 45 | 40 | 35 | 32 | |
| 75 | 75 | 73 | 72 | 70 | 68 | 66 | 64 | 62 | 60 | 58 | 55 | 52 | 49 | 45 | 41 | 36 | 32 | | |
| 70 | 70 | 68 | 67 | 65 | 63 | 61 | 59 | 57 | 55 | 53 | 50 | 47 | 44 | 40 | 37 | 32 | | | |
| 65 | 65 | 63 | 62 | 60 | 59 | 57 | 55 | 53 | 50 | 48 | 45 | 42 | 40 | 36 | 32 | | | | |
| 60 | 60 | 58 | 57 | 55 | 53 | 52 | 50 | 48 | 45 | 43 | 41 | 38 | 35 | 32 | | | | | |
| 55 | 55 | 53 | 52 | 50 | 49 | 47 | 45 | 43 | 40 | 38 | 36 | 33 | 32 | | | | | | |

| | | | | | | | | | | | |
|---|---|---|---|---|---|---|---|---|---|---|---|
| 50 | 50 | 48 | 46 | 45 | 44 | 42 | 40 | 38 | 36 | 34 | 32 |

| | | | | | | | | | |
|---|---|---|---|---|---|---|---|---|---|
| 45 | 45 | 43 | 42 | 40 | 39 | 37 | 35 | 33 | 32 |

| | | | | | | |
|---|---|---|---|---|---|---|
| 40 | 40 | 39 | 37 | 35 | 34 | 32 |

| | | | |
|---|---|---|---|
| 35 | 35 | 34 | 32 |

| | |
|---|---|
| 32 | 32 |

The dew point corresponds to the absolute humidity. The more commonly used “relative humidity” is the percentage to which the air is saturated with moisture. The dew point is simply the temperature at which the air would be saturated, would have 100% relative humidity. Warmer air can hold more moisture, so that air that would be saturated at 75° F., with 100% relative humidity, would only have about 50% relative humidity if the temperature rises to 95° F. without any moisture being added.

Since air can hold about twice as much moisture for every 20 degrees Fahrenheit, very simple equations may be used to describe the dew point. In the following equations, D is the dew point in degrees Fahrenheit, T is the air temperature, and H is the relative humidity written as a whole number percentage (i.e. “50” instead of “0.5” for “50%”). Equation (1) gives the dew point for the temperature and relative humidity, which is usually what one can easily determine, while Equation (2) gives the relative humidity from the temperature and dew point.
D=T−20*((2−log H)/log 2) Eqn. (1)
log H=2−((log 2*(T−D))/20) Eqn. (2)

A more precise value for the dew point can be derived from Equations (3) and (4) below. Using Equation (3), the value “X” is calculated first, based on the relative humidity. The temperature in Equation (4) is in degrees Celsius (or centigrade). Celsius and Fahrenheit can be converted back and forth as is well known in the art.
X=1−(0.01*H) Eqn. (3)
D=T−(14.55+0.114*T)*X−((2.5+0.007*T)*X)³−(15.9+0.117*T)*X¹⁴ Eqn. (4)

If we have a temperature of 73° F. (22.8° C.) at 24% relative humidity, the Fahrenheit equation (Equation (1)) gives us a dew point of 31.8° F. The Celsius equations (Equations (3) and (4)) give us a dew point of 1.1° C., or 34.0° F. An error of 2.2° F., or 1.2° C., is not bad, especially considering how much easier the Fahrenheit equation are to use.

In many cases, the foam controlling system 10 is installed in plants with “muggy” ambient conditions where the relative humidity (and/or temperature) is generally high. One cause of this can be that the solution or liquid 14 in the processing tank 14 emits vapor, steam 142 or the like. Thus, the dew point in the plant is expected to be high and condensation is to be generally common on surfaces.

The laser 28, in some embodiments, is water cooled and hence operates at a certain predetermined temperature or temperature range. If the ambient dew point is higher than the nominal laser temperature, undesirable condensation would cause adverse contamination of the laser optics.

Accordingly, in some embodiments, the purging fluid system 22 maintains the local dew point around and proximate the laser 28 and within the laser head housing 26 below the nominal laser temperature to reduce or substantially eliminate optics contamination by providing purging fluid 42 to the housing 26. The purging fluid 42 exits the housing 26 as fluid 42′.

The purging fluid system 22 also provides a positive pressure purge through the housing 26 to reduce or substantially eliminate optics contamination. The purging fluid 42 exits the housing 26 through the opening 140 as purging fluid 42′.

In some embodiments, the housing 26 (or laser enclosure) is environmentally controlled (with purged cooled air 42) to remove humidity and maintain a temperature that nets a lower dew point than would exist without the housing in the ambient, atmospheric or normal plant condition.

In some embodiments, the laser 28 is cooled with chilled water (68° F. nominal). If the ambient conditions above and around the processing tank 12 are, for example 90° F. at 85% relative humidity (RH), the dew point would be about 85° F. and condensation would occur, for example, in the resonator tube of the laser system. This would undesirably reduce the life of the optical devices such as mirrors of the laser system. The RF electronics associated with the laser system would also disadvantageously show enhanced degradation. By using the purging fluid system 22 to alter the environment the laser 28 is exposed to within the laser head housing 28 to 75° F. and 50% relative humidity (RH), the dew point is changed to 55° F. and no undesirable condensation occurs. In addition, and advantageously, the laser system electronics also are not strained.

In one embodiment, the tank 12 is provided in an atmosphere which has a dew point substantially the same or higher than the temperature along at least a portion of the beam path 38 within the housing 26. In one embodiment, the dew point along at least a portion of the beam path 38 within the housing 26 is less than the temperature along that portion of the beam path 38 within the housing 26.

In some embodiments, when the fluid purging system 22 reduces the dew point along at least a portion of the beam path 38 within the housing 26, it reduces the humidity or relative humidity along at least that portion of the beam path 38 within the housing 26. In some embodiments, when the fluid purging system 22 reduces the dew point along at least a portion of the beam path 38 within the housing 26, it reduces the temperature along at least that portion of the beam path 38 within the housing 26.

In some embodiments, the dew point is reduced along a predetermined portion of the beam path 38 within the housing 26 and the dew point is less than the temperature along at least that predetermined portion of the beam path 38 within the housing 26. In one embodiment, the temperature along at least that predetermined portion of the beam path 38 within the housing 26 is the laser temperature.

In some embodiments, the dew point along at least a portion of the beam path 38 within the housing 26 is less than an ambient temperature in which the tank 12 is provided. In one embodiment, this ambient temperature is a plant temperature and the tank 12 and the housing 26 are provided in the plant.

### Other Embodiments

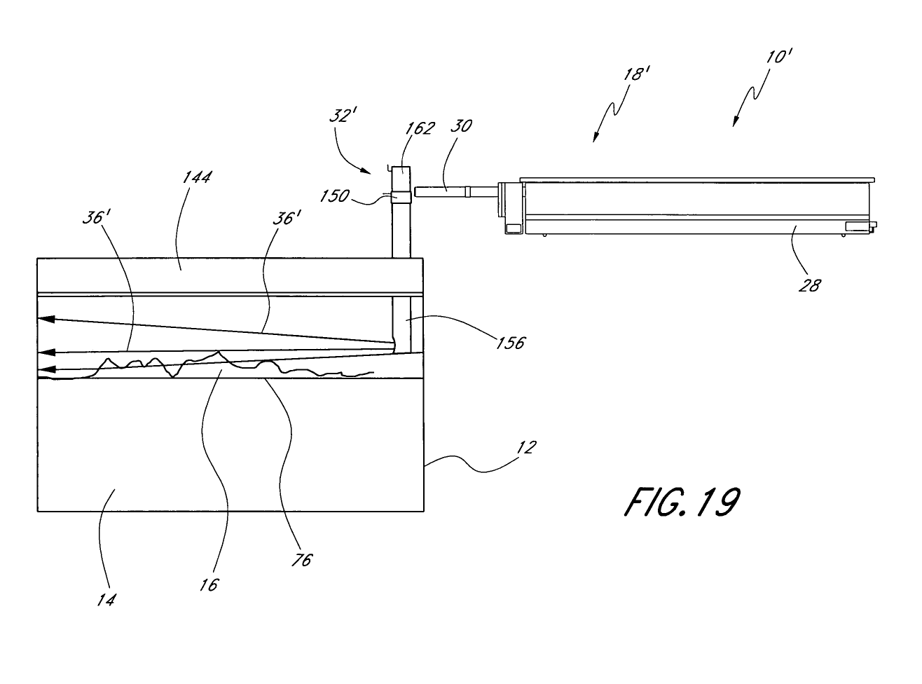

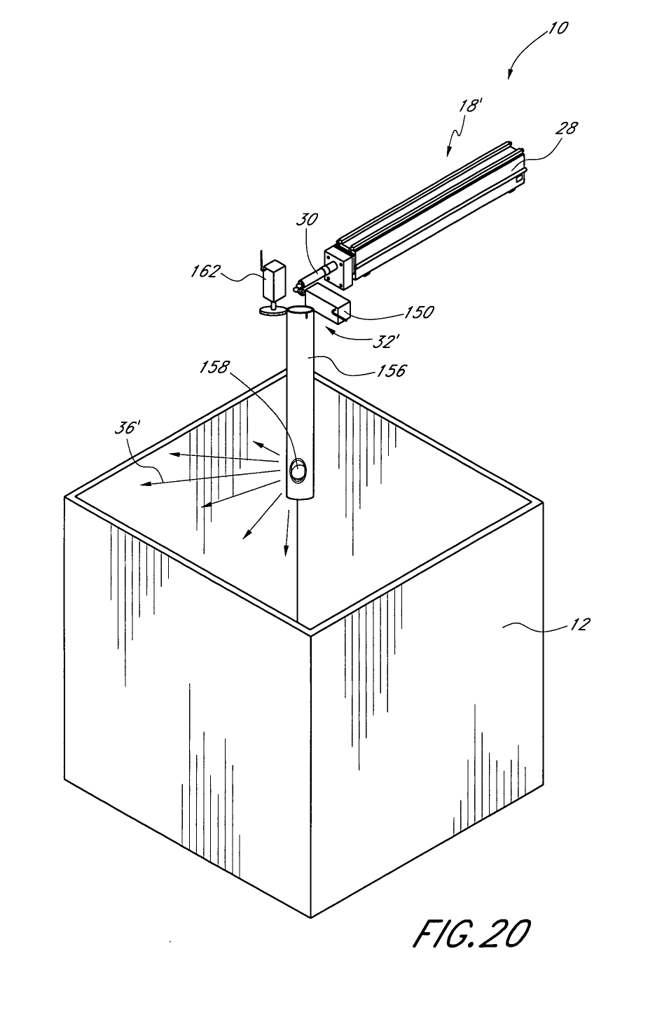

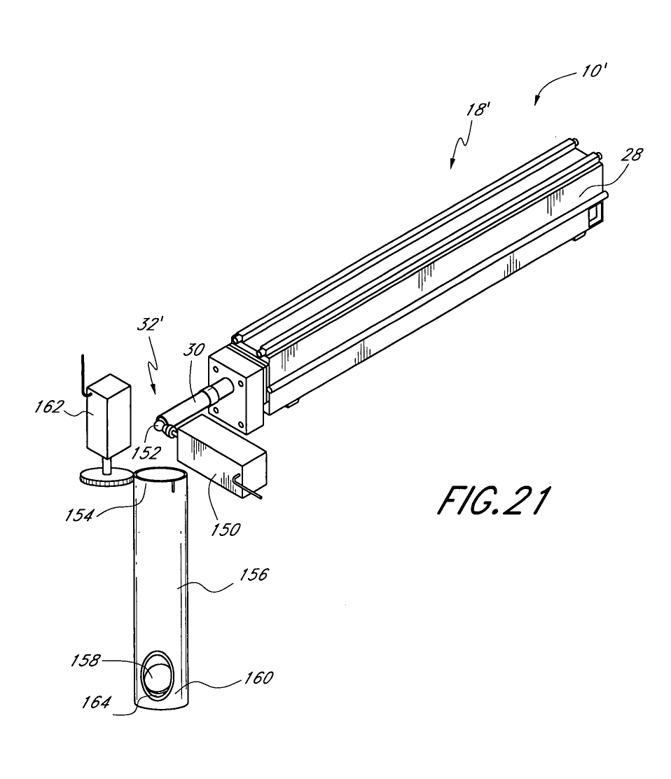

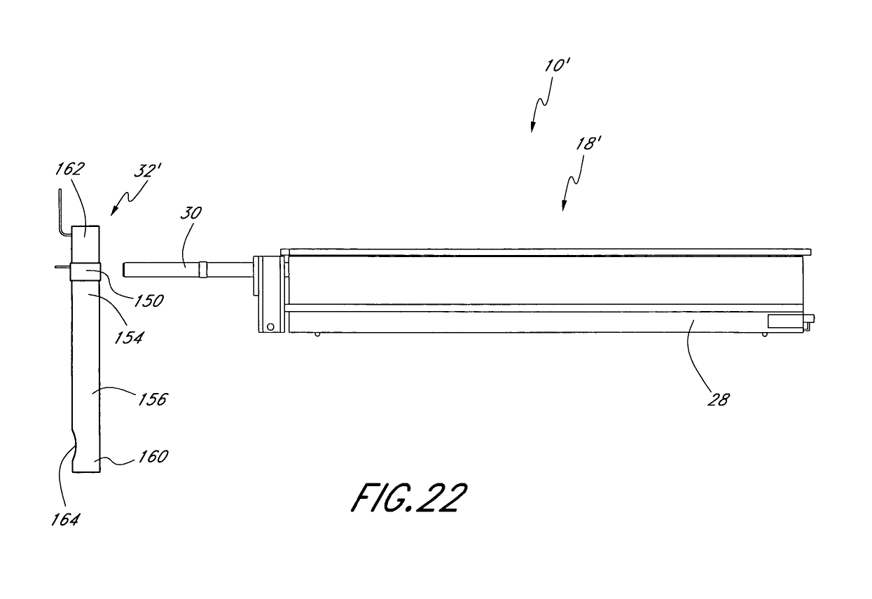

FIGS. 19-22 show different views of modified embodiments of a system for controlling foaming 10′. Though not shown in the drawings, the system 10′ comprises a control and monitoring system and a laser head enclosure connected by a duct and a fluid purging system among any other associated components as has been taught or suggested herein in connection with other embodiments of the system 10 described above. Any of the processes and methods as taught or suggested herein in connection with embodiments of the system 10 are applicable to the system 10′, as appropriate and applicable.

Embodiments of the foam controlling system 10′ are specially designed for enclosed tanks, vats, vessels, systems or chambers 12 where space is a premium and access to the foam 16 is obstructed by, for example, a lid or cover 144. Certain embodiments of the system 10′ are particularly suited to cut the foam 16 by the electromagnetic or laser beam 36′ at an angle, down to the surface 76 of the solution or liquid 14.

The laser and scanning distribution system (laser head unit) 18′ generally comprises the laser 28, the lens system, beam expander or collimator 30 and the scanning distribution system, scanning system or scanner 32′. The scanning system 32′ is also referred to in some cases as a “periscope” scanner.

The scanning system 32′ generally comprises a top galvanometer 150 coupled to a top rotatable and movable mirror 152 above a proximal portion or end 154 of a periscope or hollow tube 156 to guide the electromagnetic beam from the laser 28 therethrough to a second rotatable and movable mirror 158 coupled to a second galvanometer (not shown) at a distal portion or end 160 of the periscope tube 156 to direct the electromagnetic beam 36′ through a distal opening 164 along a beam path at an angle towards the foam 16 to cause foam dissipation and collapse. A servo or stepper motor 162 connected to the proximal portion or end 154 of the periscope tube 156 advantageously allows the periscope 156 to rotate up to 360° for lateral as well as vertical scanning.

Another embodiment comprises an ultra-violet (UV) laser as the source of electromagnetic energy or radiation. Scanning systems similar to those disclosed herein can be utilized such as those comprising galvanometer systems and the like. The ultra-violet laser may be operated in the pulsed or continuous mode, as needed or desired. The ultra-violet (UV) radiation utilized includes, but is not limited to, Extreme UV, e.g., with a wavelength less than about 150 nanometer (nm).

In yet another embodiment, a microwave system is used as the source of electromagnetic energy or radiation. A focusing system or element in conjunction with scanning systems similar to those disclosed herein can be utilized such as those comprising galvanometer systems and the like.

Some foam controlling systems in accordance with certain embodiments provide electromagnetic radiation having wavelengths including substantially the entire infrared (IR) range. In one embodiment, these wavelengths are in the range from about 3 microns (μm) to about 10.6 microns (μm).

Some foam controlling systems in accordance with certain embodiments provide electromagnetic radiation having wavelengths including substantially the entire ultraviolet (UV) range. In one embodiment, these wavelengths are substantially in the extreme ultraviolet (UV) range and have wavelengths in the range from about 100 nanometers (nm) to about 163 nanometers (nm).

Advantageously, certain embodiments of the invention provide systems and methods for controlling, reducing and/or substantially eliminating foam in aqueous, non-aqueous or liquid processes. By eliminating the undesirable usage of anti-foam or defoaming chemicals the foam controlling system of certain embodiments of the invention is a desirably economical solution for controlling foam in aqueous, non-aqueous and liquid processes. Compared to other mechanical processes, advantageously, the foam controlling system in accordance with certain embodiments of the invention is adaptable and scalable.

It is to be understood that any range of values disclosed, taught or suggested herein comprises all values and sub-ranges therebetween. For example, a range from 5 to 10 will comprise all numerical values between 5 and 10 and all sub-ranges between 5 and 10.

From the foregoing description, it will be appreciated that a novel approach for controlling foaming has been disclosed. While the components, techniques and aspects of the invention have been described with a certain degree of particularity, it is manifest that many changes may be made in the specific designs, constructions and methodology herein above described without departing from the spirit and scope of this disclosure.

While a number of preferred embodiments of the invention and variations thereof have been described in detail, other modifications and methods of using and medical applications for the same will be apparent to those of skill in the art. Accordingly, it should be understood that various applications, modifications, and substitutions may be made of equivalents without departing from the spirit of the invention or the scope of the claims.

Various modifications and applications of the invention may occur to those who are skilled in the art, without departing from the true spirit or scope of the invention. It should be understood that the invention is not limited to the embodiments set forth herein for purposes of exemplification, but is to be defined only by a fair reading of the claims, including the full range of equivalency to which each element thereof is entitled.

What is claimed is:

1. A process for controlling foaming, comprising:
providing a tank containing a liquid which generates foam, said tank having fluid flow dynamics which cause foam generated by said liquid to form a patch of foam which increases in size so as to propagate foam in a layer on a surface of the liquid towards a perimeter of said tank; and
cutting said foam into at least two portions prior to said propagating layer reaching substantially the entire perimeter of said tank, such that currents within said liquid dissipate at least one of said portions of foam.

2. The process of claim 1, wherein cutting said foam comprises using a source of electromagnetic radiation.

3. The process of claim 2, wherein said source of electromagnetic radiation comprises a laser.

4. The process of claim 3, wherein said laser comprises a carbon dioxide laser.

5. The process of claim 1, wherein said liquid comprises water.

6. The process of claim 1, wherein said liquid comprises an aqueous solution.

7. The process of claim 1, wherein said liquid comprises a non-aqueous solution.

8. The process of claim 1, wherein said tank contains organic matter in contact with said liquid.

9. The process of claim 8, wherein said organic matter comprises an agricultural product.

10. The process of claim 9, wherein said agricultural product comprises potatoes.

11. The process of claim 1, wherein said foam is generated by agitation.

12. The process of claim 1, wherein said foam is generated by fluid flow currents.

13. The process of claim 1, wherein said foam is generated by a chemical reaction.

14. The process of claim 1, wherein said tank comprises at least one inlet through which said liquid enters said tank.

15. The process of claim 1, wherein said tank comprises at least one outlet through which said liquid exits said tank.

16. The process of claim 1, wherein the foam is generated in a relatively stagnant area of said surface of said liquid.

17. The process of claim 1, wherein the foam is dissipated in a relatively agitated area of said surface of said liquid.

18. The process of claim 1, wherein cutting said foam comprises cutting said foam from the top, down to said surface of said liquid.

19. The process of claim 1, wherein cutting said foam comprises cutting said foam at an angle, down to said surface of said liquid.

20. The process of claim 1, wherein cutting said foam comprises cutting said foam into a plurality of portions.

21. The process of claim 1, wherein cutting said foam occurs at a corner and/or at one or more sides of said tank.

22. The process of claim 1, wherein cutting said foam comprises cutting said foam in a predetermined cutting pattern.

23. The process of claim 22, wherein said cutting pattern comprises a spiral cutting pattern.

24. The process of claim 22, wherein said cutting pattern comprises a raster cutting pattern.

25. The process of claim 22, wherein said cutting pattern comprises a petal cutting pattern.

26. The process of claim 22, wherein said cutting pattern comprises a rectangular cutting pattern.

27. The process of claim 22, wherein said cutting pattern comprises a circular cutting pattern.

28. The process of claim 22, wherein said cutting pattern comprises a toggled cutting pattern.

29. The process of claim 1, wherein said surface of said liquid emits vapor.

30. The process of claim 1, wherein said surface of said liquid emits steam.

31. A method for controlling foaming, comprising:
providing a tank containing a liquid which generates foam;
directing a beam of electromagnetic radiation along a beam path towards said foam through at least a portion of a housing; and
reducing dew point along a portion of said beam path within said housing by directing a flow of purging fluid through at least a portion of said housing and out of an opening in said housing.

32. The method of claim 31, wherein said electromagnetic radiation is provided by a laser.

33. The method of claim 32, wherein said laser comprises a carbon dioxide laser.

34. The method of claim 32, wherein said laser is within said housing.

35. The method of claim 31, wherein said method further comprises providing optics within said housing.

36. The method of claim 31, wherein said purging fluid comprises cooled air.

37. The method of claim 31, wherein said method further comprises providing a computer to control said beam.

38. The method of claim 37, wherein said method further comprises providing an antenna to allow remote control of said computer.

39. The method of claim 31, wherein said tank has fluid flow dynamics which cause foam generated by said liquid to form a patch of foam which increases in size so as to propagate foam in a layer on a surface of the liquid towards a perimeter of said tank.

40. The method of claim 39, wherein said electromagnetic radiation cuts said foam into at least two portions prior to said propagating layer reaching substantially the entire perimeter of said tank, such that currents within said liquid dissipate at least one of said portions of foam.

41. The method of claim 31, wherein said foam is generated by fluid flow currents within said liquid.

42. The method of claim 31, wherein said foam is generated by a chemical reaction within said tank.

43. The method of claim 31, wherein said tank is provided in an atmosphere which has a dew point substantially the same or higher than a temperature along said portion of said beam path.

44. The method of claim 31, wherein the dew point is less than a temperature along said portion of said beam path.

45. The method of claim 31, wherein said method further comprises providing a positive pressure purge through said housing to reduce or substantially eliminate optics contamination.

46. The method of claim 31, wherein reducing dew point comprises reducing humidity.

47. The method of claim 31, wherein reducing dew point comprises reducing temperature.

48. The method of claim 31, wherein the dew point is reduced along a predetermined portion of said beam path and the dew point is less than a temperature along at least the predetermined portion of said beam path.

49. The method of claim 48, wherein the temperature is a laser temperature.

50. The method of claim 31, wherein the dew point is less than an ambient temperature in which said tank is provided.

51. The method of claim 50, wherein said ambient temperature is a plant temperature and said tank and said housing are provided in said plant.

52. An apparatus for controlling foaming in a tank containing a liquid which generates foam, comprising:
a housing;
a source of electromagnetic radiation which produces an electromagnetic beam, said beam propagating along a beam path through at least a portion of said housing and towards said foam; and
a source of purging fluid which provides said purging fluid to said housing such that dew point along a portion of said beam path within said housing is reduced.

53. The apparatus of claim 52, wherein said source of electromagnetic radiation comprises a laser.

54. The apparatus of claim 53, wherein said laser comprises a carbon dioxide laser.

55. The apparatus of claim 53, wherein said laser is within said housing.

56. The apparatus of claim 52, wherein said apparatus further comprises optics within said housing.

57. The apparatus of claim 52, wherein said purging fluid comprises cooled air.

58. The apparatus of claim 52, wherein said apparatus further comprises a computer to control said beam.

59. The apparatus of claim 58, wherein said apparatus further comprises an antenna to allow remote control of said computer.

60. The apparatus of claim 58, wherein said apparatus further comprises a personal digital assistant or other hand held wireless device to communicate with said computer.

61. The apparatus of claim 52, wherein said source of purging fluid comprises a heat exchanger.

62. The apparatus of claim 61, wherein said source of purging fluid further comprises a fan.

63. The apparatus of claim 52, wherein said source of purging fluid comprises at least one vortex type air cooler.

64. The apparatus of claim 63, wherein said source of purging fluid further comprises at least one coanda effect air amplifier.

65. The apparatus of claim 64, wherein said source of purging fluid further comprises a source of compressed air to power said source of purging fluid.

66. The apparatus of claim 52, wherein said apparatus further comprises a galvanometer or motor to direct said beam.

67. The apparatus of claim 52, wherein said tank has fluid flow dynamics which cause foam generated by said liquid to form a patch of foam which increases in size so as to propagate foam in a layer on a surface of the liquid towards a perimeter of said tank.

68. The apparatus of claim 67, wherein said-beam cuts said foam into at least two portions prior to said propagating layer reaching substantially the entire perimeter of said tank, such that currents within said liquid dissipate at least one of said portions of foam.

69. The apparatus of claim 52, wherein said beam exits out of one or more openings in said housing.

70. The apparatus of claim 52, wherein said purging fluid exits out of one or more openings in said housing.

71. The apparatus of claim 52, wherein said apparatus further comprises a touch screen control panel.

72. The apparatus of claim 52, wherein said housing is washable.

73. The apparatus of claim 72, wherein said housing comprises stainless steel.

74. The apparatus of claim 52, wherein said housing is configured to be mounted above said tank.

75. The apparatus of claim 52, wherein said foam is generated by fluid flow currents within said liquid.

76. The apparatus of claim 52, wherein said foam is generated by a chemical reaction within said tank.

77. The apparatus of claim 52, wherein said tank is provided in an atmosphere which has a dew point substantially the same or higher than temperature along said portion of said beam path.

78. The apparatus of claim 52, wherein the dew point is less than a temperature along said portion of said beam path.

79. The apparatus of claim 52, wherein a positive pressure purge is provided through said housing to reduce or substantially eliminate optics contamination.

80. The apparatus of claim 52, wherein reducing dew point comprises reducing humidity.

81. The apparatus of claim 52, wherein reducing dew point comprises reducing temperature.

82. The apparatus of claim 52, wherein the dew point is reduced along a predetermined portion of said beam path and the dew point is less than a temperature along at least the predetermined portion of said beam path.

83. The apparatus of claim 82, wherein the temperature is a laser temperature.

84. The apparatus of claim 52, wherein the dew point is less than an ambient temperature in which said tank is provided.

85. The apparatus of claim 84, wherein said ambient temperature is a plant temperature and said tank and said housing are provided in said plant.
